(19) United States
(12) Patent Application Publication
(10) Pub. No.: US 2017/0264555 A1
(43) Pub. Date: Sep. 14, 2017

(54) FRAME FORWARDING DEVICE, AND METHOD FOR REQUESTING SETTING OF PROCESSING FOR FLOW

(71) Applicant: FUJITSU LIMITED, Kawasaki-shi (JP)

(72) Inventor: Masashi Yonezu, Kawasaki (JP)

(73) Assignee: FUJITSU LIMITED, Kawasaki-shi (JP)

(21) Appl. No.: 15/453,560

(22) Filed: Mar. 8, 2017

(30) Foreign Application Priority Data
Mar. 10, 2016 (JP) 2016-046864

(51) Int. Cl. H04L 12/851; H04L 12/741

(52) U.S. Cl. CPC H04L 47/2441; H04L 45/745

(57) ABSTRACT

A frame forwarding device includes a receiver that receives a frame, a storage that stores in association with each other a condition of a flow that includes a plurality of frames having common identification information and that is a target of processing, and a processing content that is set by a control device, and a processor is configured to perform, on the received frame, a processing content that is stored in association with a condition matching identification information of the received frame. In a case of requesting the control device to set a processing content for the received frame, the processor is configured to determine, according to a flow type of the received frame, whether to transmit a setting request message regarding the received frame to the control device or not.

### CROSS-REFERENCE TO RELATED APPLICATION

This application is based upon and claims the benefit of priority of the prior Japanese Patent Application No. 2016-046864, filed on Mar. 10, 2016, the entire contents of which are incorporated herein by reference.

### FIELD

The present invention relates to a frame forwarding device and a method for requesting setting of processing for a flow.

### BACKGROUND

In a software defined network (SDN), behavior of a device called a switch may be set by a device called a controller. One of the protocols used for communication between the controller and the switch in the SDN is OpenFlow.

According to OpenFlow, the switch processes packets according to a flow table. An entry in the flow table is referred to as a flow entry. The flow entry includes a condition of a target flow, and information about a process to be performed on a packet in the target flow. The flow is a collection of packets identified by flow identification information. The flow identification information includes at least one of a destination IP address, a destination MAC address, a destination port number, a source port number, and a VLAN ID, for example. Which piece of information is to be used for flow identification is specified by the specification of OpenFlow, for example.

As the method for controlling a flow entry, OpenFlow includes a proactive method and a reactive method. The proactive method is a control method according to which the controller sets a flow entry in the switch in advance. The reactive method is a control method according to which, in a case where the switch receives an unknown frame, the switch requests the controller for the flow entry for the unknown frame, and the controller determines, and sets in the switch, the flow entry for the unknown frame. An unknown frame refers to a frame the flow entry for whose flow is not set. The request from the switch to the controller for setting of the flow entry for the unknown frame uses a PacketIn message. In the following, a PacketIn message will be referred to simply as a PacketIn. Also, in the present specification, a frame and a packet are not particularly distinguished from each other.

FIG. 16 is a diagram illustrating an example of processing according to the reactive method. In S1, a switch P1 receives a frame which is the target of PacketIn transmission. For example, an unknown frame which does not match the condition of any flow entry in which a forwarding process or the like is set is made the target of PacketIn transmission. The processing is suspended for the PacketIn target frame.

In S2, the switch P1 transmits the PacketIn to a controller P2. In S3, the controller P2, based on the contents of the frame indicated by the PacketIn, determines a process to be performed by the switch P1 on the corresponding flow, and transmits a FlowMod message to the switch P1. The FlowMod message is a message which includes a flow entry and which instructs the switch P1 to register, delete or change the flow entry. In the following, the FlowMod message will be referred to simply as a FlowMod.

In S4, the switch P1 receives the FlowMod, registers the flow entry included in the FlowMod in the flow table, and overwrites the flow table.

In S5, the controller P2 transmits, to the switch P1, a PacketOut message, corresponding to the PacketIn, instructing output of the frame received by the switch P2 in S1. The PacketOut message is a message which is used to instruct the switch P2 to output a packet. In the following, the PacketOut message will be referred to simply as a PacketOut.

In S6, the switch P1 forwards or discards, according to the updated flow table, the frame which is received in S1 and for which the processing is suspended.

### PATENT DOCUMENT

[Patent document 1] Japanese Patent Application Domestic Laid-Open Publication No. 2014-502794

However, according to the control by the reactive method, if frames which are targets of PacketIn transmission sequentially reach the switch P1 between transmission of a PacketIn and reception of a FlowMod, following problems may occur.

FIG. 17 is a diagram illustrating an example of processing according to control by the reactive method. For example, in FIG. 17, frames #1 to #4 of respective flows A, B, which are targets of PacketIn transmission, sequentially reach the switch P1. The switch P1 transmits the PacketIn for each of the frames of the flows A, B until a FlowMod for a PacketIn for one of the frames of the flows A, B is received.

For example, even after transmission of the PacketIn for the frame #1 of the flow A, the switch P1 of the example illustrated in FIG. 17 transmits the PacketIns for the frames #2 to #4 of the flow A until a FlowMod is received. In the same manner, the PacketIn is transmitted for each of the frames #1 to #4 of the flow B.

The PacketIns for the frames of the flows A, B are concentrated at the controller P2. For example, in the case where the flow A is a transmission control protocol (TCP) flow, and is a flow for continuously forwarding data of a large window size, a great number of frames of the flow A are continuously input to the switch P1. The switch P1 transmits, to the controller P2, the PacketIn for each input frame of the flow A until a flow entry for the flow A is registered. When the PacketIns for the frames of the flow A are concentrated at the controller P2, processing congestion may be caused at the controller P2. When a great number of PacketIns for the flow A are input to the controller P2, transmission, by the controller P2, of a FlowMod for a PacketIn for a flow other than the flow A is delayed. This may result in further generation and transmission of PacketIns by the switch P1, and an increase in the PacketIns input to the controller P2.

Furthermore, depending on the type of the controller P2, multiple input of FlowMods is performed, according to which FlowMod messages are transmitted for all the PacketIns for a plurality of frames of one flow. In this case, FlowMods including a flow entry of the same contents reach the switch P1 in an overlapping manner. When a FlowMod is received, the switch P1 checks a flow entry indicated by the FlowMod against a flow entry that is registered in the flow table. Checking of the flow table is a high-load process for the switch P1. Accordingly, in the case where there is a large number of PacketIns for one flow, the number of FlowMods received by the switch P1 is also increased, and the processing load on the switch P1, in addition to the controller P2, is possibly increased.

As a method for suppressing processing congestion at the controller P2 caused by PacketIns, OpenFlow provides a restriction on transmission rate of the PacketIns. However, in the case where there is a restriction on the transmission rate of the PacketIns, if the transmission rate of the PacketIns exceeds the upper limit, the PacketIns may be discarded at the switch P1 as one process for adjusting the transmission rate, for example. Accordingly, the upper limit of the transmission rate may be reached by occurrence of an unexpected number of PacketIns for a specific flow, and the PacketIns for other flows may possibly be discarded. The controller P2 is not able to detect presence of a PacketIn for a flow whose PacketIn is discarded. Accordingly, if a frame of the corresponding flow reaches the switch P1 again, the PacketIn is transmitted again. This accelerates occurrence of PacketIns, and control of the flow of the discarded PacketIn is delayed.

Also, in the case where there is a restriction on the transmission rate of the PacketIns, a large number of PacketIns are held in the switch P1. Accordingly, the time from occurrence of a PacketIn at the switch P1 to transmission of the PacketIn to the controller P2 is increased. The buffer retention time when a packet which is the target of PacketIn transmission is held in a buffer at the switch P1 is determined in advance by the administrator. The buffer retention time may sometimes run out before the switch P1 receives a FlowMod and a PacketOut from the controller P2 with respect to a PacketIn, and a packet which is the target of PacketOut may no longer exist.

In the case where a packet which is the target of PacketOut does not exist, the switch P1 is to return to the controller P2 an error indicating that “buffer does not exist”. The processing load on the switch P1 and the controller P2 is possibly increased due to this error processing.

### SUMMARY

A mode of the present invention is a frame forwarding device includes a receiver that receives a frame, a storage that stores in association with each other a condition of a flow that includes a plurality of frames having common identification information and that is a target of processing, and a processing content that is set by a control device, and a processor is configured to perform, on the received frame, a processing content that is stored in association with a condition matching identification information of the received frame. In a case of requesting the control device to set a processing content for the received frame, the processor is configured to determine, according to a flow type of the received frame, whether to transmit a setting request message regarding the received frame to the control device or not.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWING

FIG. 1 is a diagram illustrating an example configuration of a network system according to a first embodiment;

FIG. 2 is a diagram illustrating an example of processing for a flow which is a target of guaranteed PacketIn according to the first embodiment;

FIG. 3 is a diagram illustrating an example of a process for restricting the transmission rate of PacketIns according to the first embodiment;

FIG. 4 is a diagram illustrating an example of hardware configuration of a switch;

FIG. 5 is a diagram illustrating an example of functional configuration of the switch;

FIG. 6 is an example of a flow table;

FIG. 7 is a diagram illustrating an example of a method for using Max_len information according to the first embodiment;

FIG. 8 is a diagram illustrating an example of congestion information that is added to a guaranteed PacketIn;

FIG. 9 is a diagram illustrating an example of items included in an entry in a PacketIn control table;

FIG. 10 is a diagram illustrating an example of items in an entry in standby in a transmission queue;

FIG. 11 is a diagram illustrating an example of mutual reference between an entry in the PacketIn control table and an entry in standby in the transmission queue;

FIG. 12A is an example flowchart of a process by a PacketIn control unit performed at the time of PacketIn input;

FIG. 12B is an example flowchart of a process by the PacketIn control unit performed at the time of PacketIn input;

FIG. 12C is an example flowchart of a process by the PacketIn control unit performed at the time of PacketIn input;

FIG. 13 is an example flowchart of a process of PacketIn transmission by a transmission rate control unit;

FIG. 14 is an example flowchart of a process by the PacketIn control unit performed at the time of PacketOut input;

FIG. 15 is an example flowchart of a process performed by the PacketIn control unit when an operation guard timer runs out;

FIG. 16 is a diagram illustrating an example of processing according to a reactive method; and

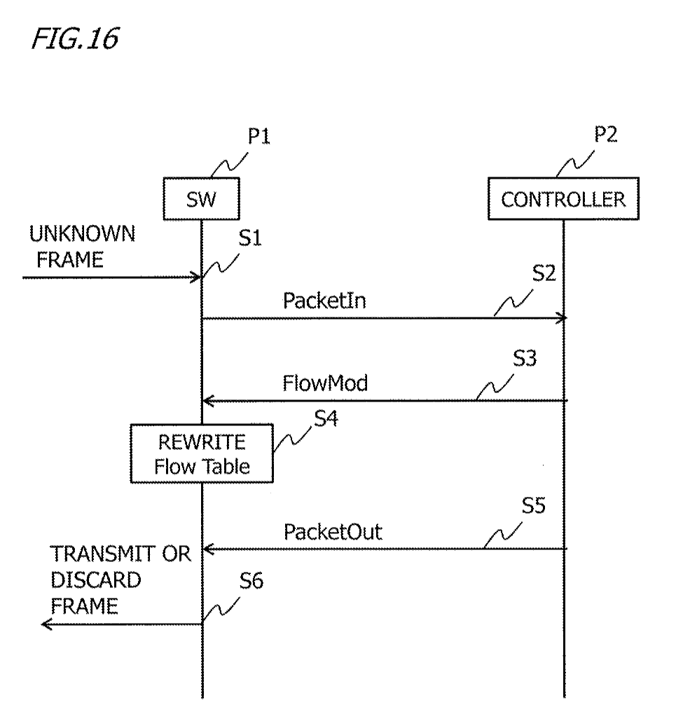

FIG. 17 is a diagram illustrating an example of processing of control according to the reactive method.

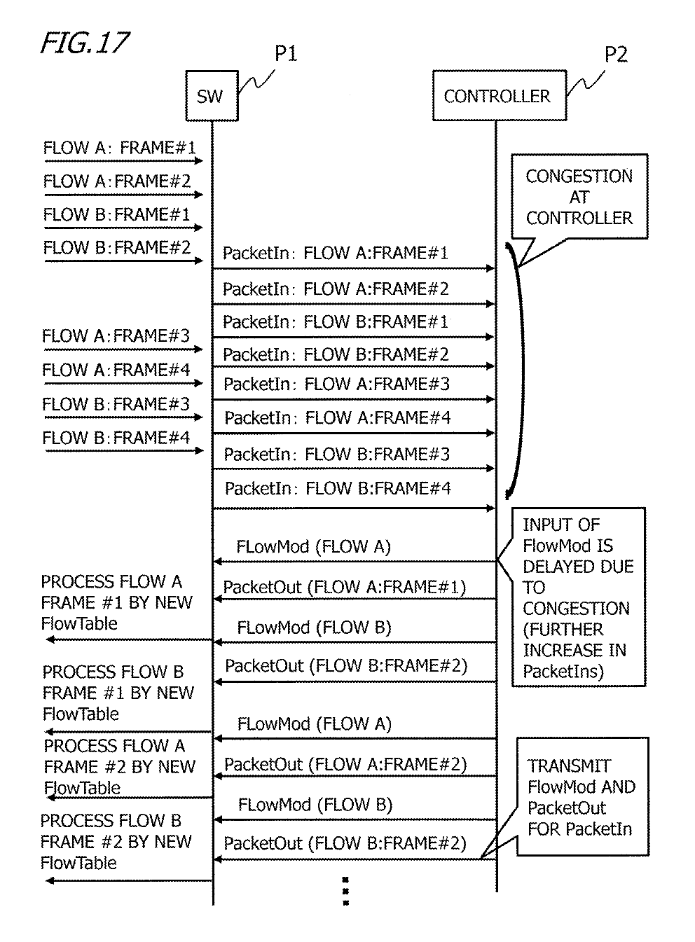

### DESCRIPTION OF EMBODIMENT

Hereinafter, an embodiment of the present invention will be described with reference to the drawings. The configuration of the embodiment below is merely an example, and the present invention is not limited to the configuration of the embodiment.

### First Embodiment

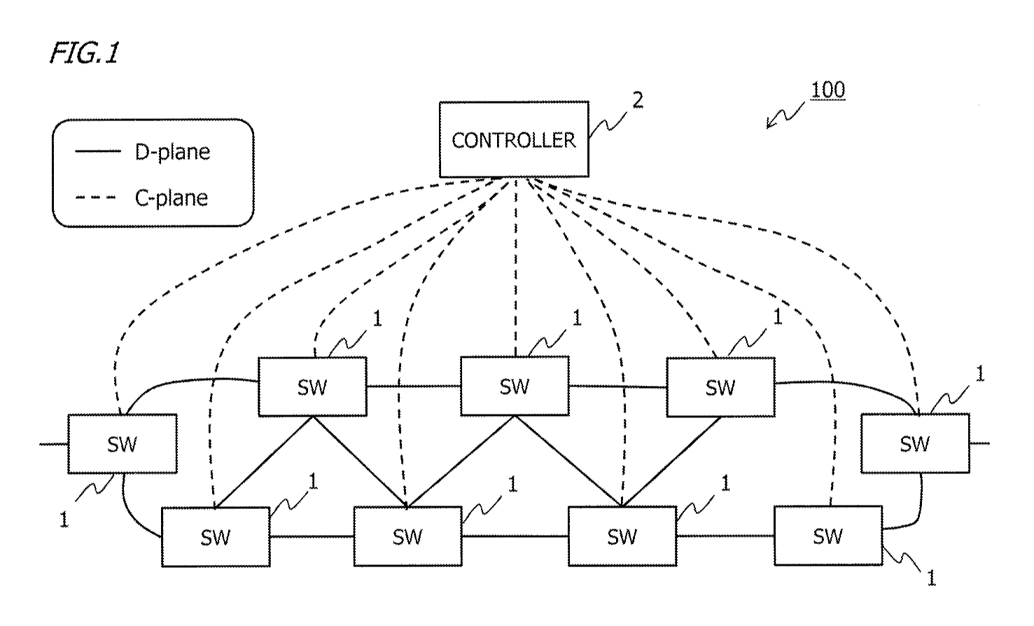

FIG. 1 is a diagram illustrating an example configuration of a network system 100 according to a first embodiment. In the first embodiment, the network system 100 is assumed to be an SDN network. The network system 100 includes a plurality of switches 1, and a controller 2. The switch 1 is an SDN switch, for example. The controller 2 is an SDN controller, for example. The SDN switch is also referred to as an OpenFlow switch. The SDN controller is also referred to as an OpenFlow controller.

In the network system 100, a network connecting the switches 1 and the controller 2, and a network where user data passes through are separated. A control signal for transmitting control information is exchanged between the switch 1 and the controller 2. A protocol handling the control signal between the switch 1 and the controller 2 is called a control plane. In the first embodiment, OpenFlow is assumed to be used on the control plane. A protocol handling a user signal for transmitting user data that is relayed between the switches 1 is called a data plane.

In the first embodiment, the switch 1 transmits, to the controller 2, a PacketIn for one frame among frames of one flow, and does not transmit PacketIns for other frames. On the other hand, with respect to the one PacketIn that is transmitted, to guarantee transmission to the controller 2, the PacketIn is excluded from the target for discard for adjustment of the transmission rate of PacketIns. The switch 1 thereby suppresses an increase in the processing load on the controller 2 and the switch 1 itself. The frame for which the PacketIn is transmitted, among the frames included in the one flow, is the latest frame or the earliest frame in a predetermined period of time.

In the first embodiment, the processing described above is performed not for all the flows but for one or some of the flows. The PacketIn for a flow which is the target of the processing described above will be hereinafter referred to as a guaranteed PacketIn. The PacketIn for a flow which is not the target of the processing described above, that is, the PacketIn which is to be subjected to conventional processing, will be hereinafter referred to as a non-guaranteed PacketIn.

The PacketIn is an example of a “setting request message”. The non-guaranteed PacketIn is an example of a “first setting request message”. The guaranteed PacketIn is an example of a “second setting request message”.

The target of the guaranteed PacketIn is a frame of user data, for example. As the frame of user data, there are a TCP (Transmission Control Protocol) frame and a UDP (User Datagram Protocol) frame, for example. With the frame of user data, even if the PacketIn is discarded, normality of communication is maintained in many cases by the function of an upper layer protocol. The target of the non-guaranteed PacketIn is a flow with respect to which PacketIns may be discarded at the time of congestion but all the PacketIns are desirably transmitted to the controller 2 on a best-effort basis. As other examples of the target of the guaranteed PacketIn, there are an ARP (Address Resolution Protocol) frame and an LLDP (Link Layer Discovery Protocol) frame, for example. This is because the PacketIns are desirably reliably transmitted to the controller 2 for these frames. A target frame for which the guaranteed PacketIn is to be generated is set by a flow entry.

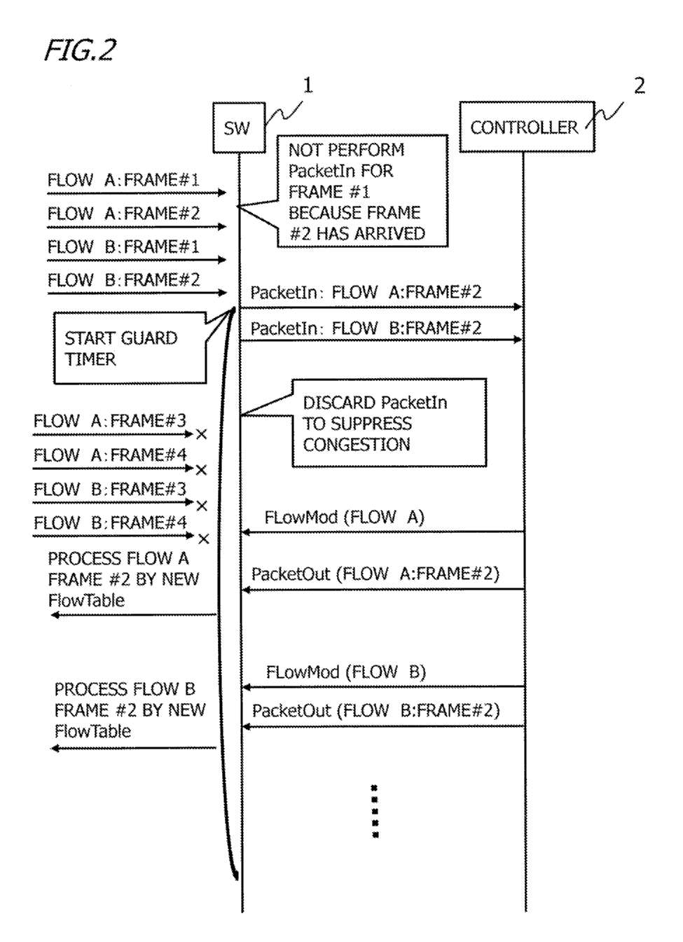

FIG. 2 is a diagram illustrating an example of processing for a flow which is the target of the guaranteed PacketIn according to the first embodiment. In FIG. 2, the switch 1 successively receives frames #1, #2 of each of flows A, B. The flows A, B are flows which are the targets of the guaranteed PacketIn.

The switch 1 transmits, to the controller 2, the PacketIn for one frame for each of the flows A, B. In FIG. 2, the PacketIn is transmitted for the latest frame #2 for both the flows A, B. For both the flows A, B, the PacketIn for the frame #1 is not transmitted, being discarded at a time point of occurrence of the PacketIn for the frame #2.

After transmitting the PacketIn for the flow A, the switch 1 starts a guard timer for the flow A. Even if a frame of the flow A is received, the switch 1 does not transmit the PacketIn to the controller 2 until the guard timer is expired, and positively discards the PacketIn. The same is applied to the flow B. In FIG. 2, the PacketIns for frames #3, #4, of each of the flows A, B, arriving at the switch 1 after start of the guard timer are discarded.

When a FlowMod for the PacketIn for the frame #2 of the flow A is received from the controller 2, a flow entry including processing for the flow A is registered in a flow table of the switch 1. When a PacketOut for the PacketIn for the frame #2 of the flow A is received from the controller 2, the frame #2 of the flow A is processed according to the updated flow table and is output. The guard timer for the flow A is cancelled by reception of the PacketOut. Also with respect to the flow B, the FlowMod and the PacketOut are received from the controller 2, and the guard timer is cancelled. Reception of the FlowMod or the PacketOut is an example of “reception of setting of a processing content for a flow”.

In the case where a frame of the flow A reaches the switch 1 after the guard timer is cancelled, because a flow entry for the flow A is present in the flow table, the frame of the flow A is output from the switch 1 according to the flow entry. Additionally, in the example illustrated in FIG. 2, frame main bodies of the frames #1, #3, #4 of the flow A whose PacketIns are discarded are also discarded. The discarded frames are rescued by a retransmission function or the like of an upper layer.

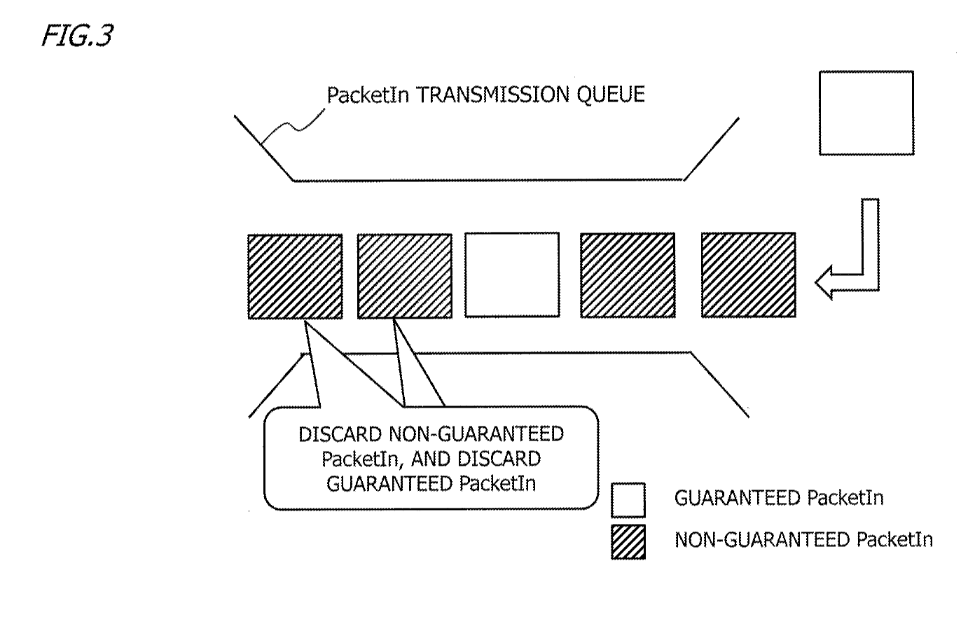

FIG. 3 is a diagram illustrating an example of a process for restricting the transmission rate of PacketIns according to the first embodiment. FIG. 3 illustrates a transmission queue for PacketIns. Both the guaranteed and non-guaranteed PacketIns in standby are stored in the PacketIn transmission queue.

In the first embodiment, to guarantee transmission of a guaranteed PacketIn to the controller 2, the switch 1 performs the following process. If the transmission rate is exceeding the transmittable rate at the time of transmission of a PacketIn, the switch 1 discards a non-guaranteed PacketIn in the PacketIn transmission queue. At this time, the guaranteed PacketIn in the PacketIn transmission queue is excluded from the target of discard. Additionally, in the first embodiment, transmission of a PacketIn means taking out a PacketIn from the PacketIn transmission queue and transmitting the PacketIn.

As described, the guaranteed PacketIn is not discarded from the transmission queue even when the transmission rate is exceeding the transmittable rate. Therefore, transmission of the guaranteed PacketIn to the controller 2 is guaranteed.

<Device Configuration>

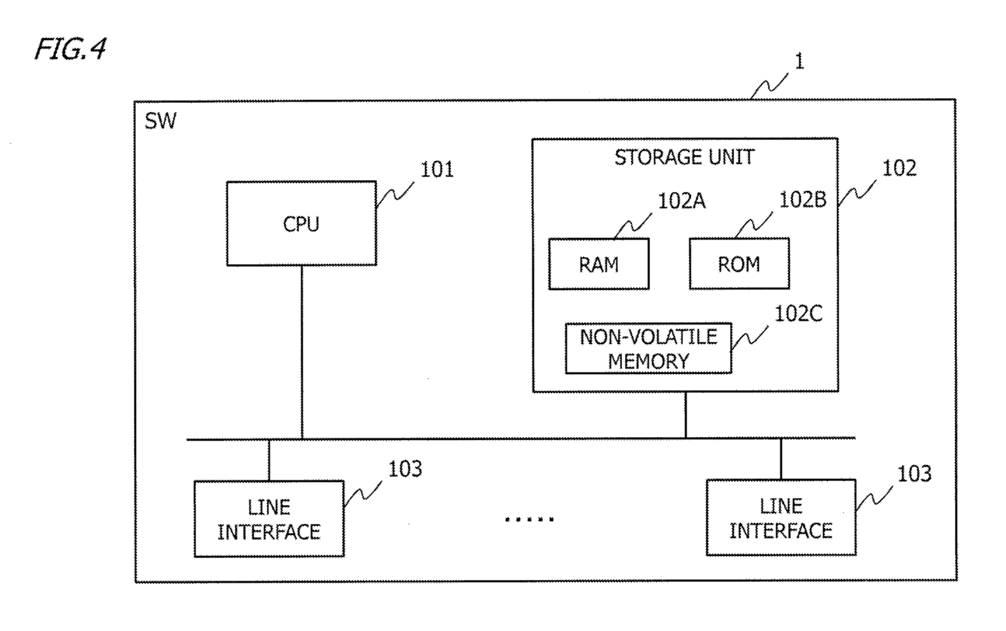

FIG. 4 is a diagram illustrating an example of hardware configuration of the switch 1. The switch 1 is an OpenFlow switch, a Layer 3 switch or the like, for example. The switch 1 includes a CPU (Central Processing Unit) 101, a storage unit 102, and line interfaces 103. The CPU 101, the storage unit 102, and the line interfaces 103 are electrically connected by a bus. The switch 1 is an example of a “frame forwarding device”.

The storage unit 102 includes a RAM (Random Access Memory) 102A, a ROM (Read Only Memory) 102B, and a non-volatile memory 102C. The RAM 102A is a semiconductor memory such as a DRAM (Dynamic RAM), an SRAM (Static RAM), or an SDRAM (Synchronous DRAM). The RAM 102A provides the CPU 101 with a work area for loading programs stored in the ROM 102B and the non-volatile memory 102C, or is used as a buffer. The ROM 102B stores a BIOS (Basic Input/Output System) and the like. The RAM 102A and the ROM 102B are used as main storage devices.

The non-volatile memory 102C stores an OS (Operating System), an OpenFlow program, a guaranteed PacketIn execution program, other application programs, and data to be used by the CPU 101, for example. The non-volatile memory 102C is an EPROM (Erasable Programmable ROM) or a hard disk drive, for example. The OpenFlow program is a program for causing the switch 1 to perform a process specified by OpenFlow. The guaranteed PacketIn execution program is a program for causing the switch 1 to perform processing of a guaranteed PacketIn. The guaranteed PacketIn execution program may be one of modules of the OpenFlow program, for example. The non-volatile memory 102C is used as an auxiliary storage device.

The CPU 101 performs various processes by loading the OS or a program held by the non-volatile memory 102C into the RAM 102A and executing the same. A plurality of CPUs 101 may be provided. The CPU 101 is an example of a “processor”.

The line interface 103 is a circuit and a port for connecting a cable of a wired network line, such as an optical cable or a LAN (Local Area Network) cable. The line interface 103 is an example of a “receiver”.

Additionally, the hardware configuration of the switch 1 illustrated in FIG. 4 are merely examples, and structural components may be omitted, substituted or added as appropriate according to the embodiment without being limited to the above example. For example, the switch 1 may include a processor such as a DSP (Digital Signal Processor) or a network processor, in addition to the CPU 101, for example.

The controller 2 is a dedicated or general-purpose computer, for example. The controller 2 includes a CPU, a RAM, a ROM, a non-volatile memory, a line interface, an input device such as a keyboard, and an output device such as a display. Each hardware component is basically the same as that of the switch 1, and description thereof is omitted. The controller 2 is an example of a “control device”.

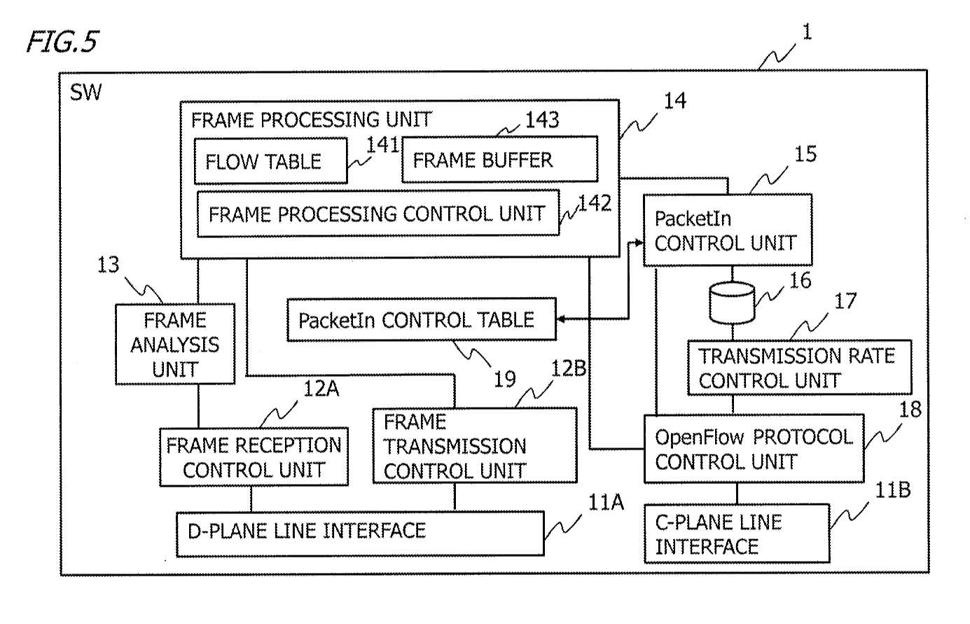

FIG. 5 is a diagram illustrating an example of functional configuration of the switch 1. As the functional components, the switch 1 includes a D-plane line interface 11A, a C-plane line interface 11B, a frame reception control unit 12A, a frame transmission control unit 12B, a frame analysis unit 13, a frame processing unit 14, a PacketIn control unit 15, a PacketIn transmission queue 16, a transmission rate control unit 17, an OpenFlow protocol control unit 18, and a PacketIn control table 19. In the following, the PacketIn transmission queue 16 will be referred to simply as the transmission queue 16.

The D-plane line interface 11A corresponds to the line interface 103 for connecting to a network to which another switch 1 is connected. The C-plane line interface 11B corresponds to the line interface 103 for connecting to a network to which the controller 2 is connected. The D-plane line interface 11A and the C-plane line interface 11B may be physical interfaces or logical interfaces.

The frame reception control unit 12A, the frame transmission control unit 12B, the frame analysis unit 13, the frame processing unit 14, and the OpenFlow protocol control unit 18 are each a functional component achieved by the CPU 101 executing the OpenFlow program. The frame reception control unit 12A outputs a frame that is input from the D-plane line interface 11A to the frame analysis unit 13. The frame transmission control unit 12B outputs a frame that is input from the frame processing unit 14 to the D-plane line interface 11A.

The frame analysis unit 13 analyzes the frame header, and specifies a flow. The frame analysis unit 13 identifies the flow by flow identification information. The flow identification information is one or a combination of a destination IP address, a source IP address, a destination MAC address, a source IP address, a TCP or UDP destination port number, a protocol ID and the like, for example. Information to be used as the flow identification information is specified in the specification of OpenFlow, for example. The frame analysis unit 13 outputs the flow identification information of the frame and the frame. The flow identification information is an example of “identification information”.

The frame processing unit 14 includes a flow table 141, a frame processing control unit 142, and a frame buffer 143. The flow table 141 is stored in the RAM 102A, for example. Details of the flow table 141 will be given later.

The frame processing control unit 142 searches through the flow table 141 with the flow identification information of a frame as the key, and processes the frame according to a frame entry matching the flow identification information. Additionally, a frame on the D-plane is processed according to the flow table 141.

For example, in the case where the flow identification information of a frame matches a flow entry instructing transmission of a PacketIn, the frame processing control unit 142 generates a PacketIn. The frame processing control unit 142 outputs the generated PacketIn and a parameter regarding the PacketIn to the PacketIn control unit 15. A parameter regarding the PacketIn includes the flow identification information of the flow of the PacketIn, information indicating guaranteed or non-guaranteed, and the like, and details thereof will be given later. Furthermore, the frame processing control unit 142 stores the frame main body in the frame buffer 143.

The frame buffer 143 holds a frame processing of which is suspended, that is, a frame main body for which the PacketIn is generated. The frame buffer 143 is created in the RAM 102A. A plurality of frame buffers 143 are provided, and these are identified by buffer IDs. When a PacketOut from the controller 2 is input, the frame main body stored in the frame buffer 143 is read from the frame buffer 143 by the frame processing control unit 142, and is processed according to an Action specified by the PacketOut. The frame buffer 143 is an example of a “frame buffer”.

Furthermore, the frame main body, stored in the frame buffer 143, for which the PacketIn has been generated is discarded when the corresponding PacketIn is discarded. Discard of a frame from the frame buffer 143 may be performed by the PacketIn control unit 15 for discarding a PacketIn or by the transmission rate control unit 17 for discarding a PacketIn. Alternatively, discard of a frame from the frame buffer 143 may be performed by the frame processing control unit 142 according to an instruction from the PacketIn control unit 15 for discarding a PacketIn or from the transmission rate control unit 17 for discarding a PacketIn.

An OpenFlow message from the controller 2 is input to the frame processing control unit 142 from the OpenFlow protocol control unit 18. The OpenFlow messages from the controller 2 which are focused on in the first embodiment are the FlowMod and the PacketOut. In a case where the FlowMod is input, the frame processing control unit 142 checks whether a flow entry included in the FlowMod is present in the flow table 141 or not, and registers the flow entry in the flow table 141.

In a case where the PacketOut is input, the frame processing control unit 142 processes the frame specified by the PacketOut according to an Action specified by the PacketOut. The PacketOut includes a buffer ID, and the frame processing control unit 142 reads a frame from the frame buffer 143 corresponding to the buffer ID included in the PacketOut. The PacketOut may also include a frame to be output by the switch 1. In the case where a frame is included in the PacketOut, the frame processing control unit 142 processes the frame included in the PacketOut according to the Action specified by the PacketOut.

Additionally, the frame processing unit 14 does not have to be achieved by the CPU 101 executing the OpenFlow program, and may be achieved by a hardware circuit such as an FPGA (Field-Programmable Gate Array). Also, processing of the frame processing unit 14 may be partly achieved by hardware. For example, a process of searching through the flow table 141 may be achieved by hardware by using a TCAM (Ternary Content Addressable Memory) for the flow table 141. In this case, the process of searching through the flow table 141 is accelerated.

The PacketIn control unit 15, the transmission queue 16, and the transmission rate control unit 17 are functional components that are achieved by the CPU 101 executing the guaranteed PacketIn execution program. A PacketIn and a parameter regarding the PacketIn are input to the PacketIn control unit 15 from the frame processing unit 14. The PacketIn control unit 15 determines whether the input PacketIn is guaranteed or non-guaranteed based on the parameter. In the case where the input PacketIn is non-guaranteed, the PacketIn control unit 15 stores the input non-guaranteed PacketIn in the transmission queue 16.

In the case where the input PacketIn is guaranteed, and is for a new flow, the PacketIn control unit 15 stores the input guaranteed PacketIn in the transmission queue 16. Also, in this case, the PacketIn control unit 15 adds a new entry in the PacketIn control table 19. Details of the PacketIn control table 19 will be given later.

In the case where the input PacketIn is guaranteed, and a PacketIn for the same flow is already stored in the transmission queue 16, the PacketIn control unit 15 determines whether to discard the input PacketIn or the guaranteed PacketIn in the transmission queue 16. This determination regarding discard is performed based on the refresh time and the retention time, in the transmission queue 16, of the existing guaranteed PacketIn in the transmission queue 16.

The refresh time is a time to be the threshold for update determination for a guaranteed PacketIn in the transmission queue 16. When the retention time of a guaranteed PacketIn in the transmission queue 16 becomes longer than the refresh time, the PacketIn control unit 15 overwrites the guaranteed PacketIn in the transmission queue 16 with a newly input guaranteed PacketIn for the same flow.

Accordingly, in the case where the retention time of a guaranteed PacketIn of a flow in the transmission queue 16 is equal to or less than the refresh time, the PacketIn control unit 15 discards a newly arriving guaranteed PacketIn of the same flow. In the case where the retention time of a guaranteed PacketIn in the transmission queue 16 is longer than the refresh time, the PacketIn control unit 15 overwrites the guaranteed PacketIn in the transmission queue 16 with a newly arriving guaranteed PacketIn of the same flow.

If the refresh time is set to 0, the guaranteed PacketIn in the transmission queue 16 is overwritten with a new guaranteed PacketIn every time a new guaranteed PacketIn of the same flow is input. Accordingly, in the case where the refresh time is 0, the guaranteed PacketIn for the latest frame is transmitted. In the case where the refresh time is not 0, the PacketIn for the earliest frame within a predetermined time preceding the current time point is transmitted. The refresh time is an example of a “first time length”.

Also, in the case where an operation guard timer is already started at the time of input of a new PacketIn, the PacketIn control unit 15 discards the new PacketIn. The operation guard timer is a timer which is started when a guaranteed PacketIn is transmitted, and which is cancelled when a PacketOut is input. Details of the operation guard timer will be given later.

Additionally, in the case where a PacketIn is discarded, the corresponding frame main body is also discarded from the frame buffer 143.

The PacketIn transmission queue 16 is a software queue. The transmission queue 16 is a FIFO (First In First Out) queue. Guaranteed and non-guaranteed PacketIns are stored in the transmission queue 16 by the PacketIn control unit 15, and the PacketIns are read out by the transmission rate control unit 17. The PacketIn transmission queue 16 is an example of a “transmission queue”.

The transmission rate control unit 17 reads out PacketIns from the transmission queue 16 within a set transmittable rate, and outputs the same to the OpenFlow protocol control unit 18. Reading of PacketIns from the transmission queue 16 is performed by using a token bucket, and when there is no token in the token bucket, the transmission rate is determined to be exceeding the transmittable rate.

In the case where the transmission rate of the PacketIns is exceeding the transmittable rate, the transmission rate control unit 17 adjusts the transmission rate by discarding non-guaranteed PacketIns in the transmission queue 16. At this time, guaranteed PacketIns in the transmission queue 16 are not made the targets of discard. Accordingly, even when the transmission rate of PacketIns is restricted, a guaranteed PacketIn is not discarded, and transmission thereof to the controller 2 is guaranteed. Additionally, when a non-guaranteed PacketIn is discarded for adjustment of the transmission rate, the corresponding frame main body is also discarded from the frame buffer 143.

The OpenFlow protocol control unit 18 controls input/output of data on the C-plane. The OpenFlow protocol control unit 18 receives input of a PacketIn from the transmission rate control unit 17, and outputs the PacketIn to the C-plane line interface 11B. Also, when a PacketOut is input from the C-plane line interface 11B, the OpenFlow protocol control unit 18 outputs the PacketOut to the frame processing unit 14 and the PacketIn control unit 15. When a FlowMod is input from the C-plane line interface 11B, the OpenFlow protocol control unit 18 outputs the FlowMod to the frame processing unit 14.

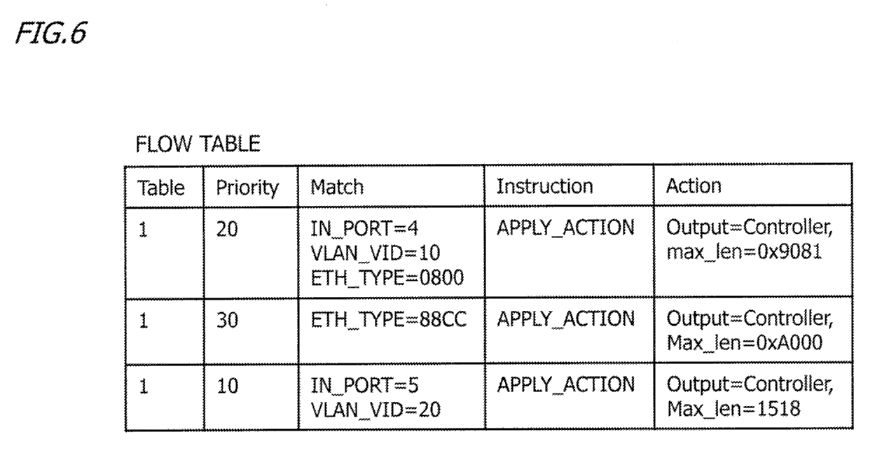

FIG. 6 is an example of the flow table 141. In FIG. 6, an example of a flow entry instructing PacketIn is illustrated. The flow entry illustrated in FIG. 6 includes items of Table, Priority, Match, Instruction, and Action. However, the items in the flow entry illustrated in FIG. 6 are just some of the items, and the items in the flow entry are not limited to those mentioned above. The flow table or the RAM 102A storing the flow table is an example of a “storage”.

The value of the item “Table” indicates the identification number of a flow table. The switch 1 is able to hold a plurality of flow tables. The value of the item “Priority” indicates the degree of priority of the corresponding flow entry. One with the greatest value of “Priority” is applied.

The value of the item “Match” indicates the condition of a flow as the target of the corresponding flow entry. A packet type, an input port, a VLAN number, a destination IP address, a source IP address, a destination MAC address, a source MAC address and the like may be specified in the item “Match”.

The value of the item “Instruction” indicates the execution timing with respect to the item of “Action” of the corresponding flow entry, movement to another flow table, and the like. “APPLY Action” in the item “Instruction” indicates execution of a process specified in the item “Action” of the corresponding flow entry.

The value of the item “Action” indicates the process to be performed on the frame of a flow corresponding to the value of the item “Match” of the corresponding flow entry. “Output=Controller” indicates a process of transmitting a PacketIn to the controller 2. “Max_len=XXXX” (XXXX is a 16-bit parameter) indicates that data from the beginning of a frame to a specified position is to be included in a PacketIn. “Output=Controller” is an example of an “instruction for transmission of a PacketIn message to a control device”.

In the first embodiment, a guaranteed PacketIn or a non-guaranteed PacketIn is specified by using “Max_len” in “Action”. The method for using the “Max_len” parameter in the first embodiment will be described later in detail.

With respect to the flow entries illustrated in FIG. 6, the flow entry whose “Priority” is “20” and the flow entry whose “Priority” is “30” are flow entries for guaranteed PacketIns. The flow entry whose “Priority” is “10” is a flow entry for a non-guaranteed PacketIn. The value of the item of Match of a flow entry is an example of a “condition”. The value of the item of Action of a flow entry is an example of a “processing content”.

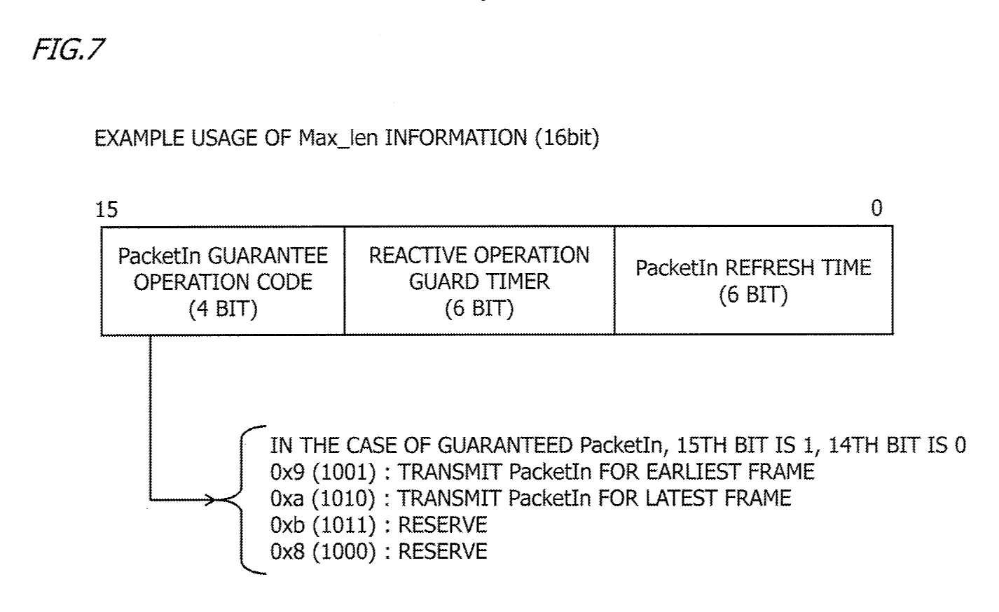

FIG. 7 is a diagram illustrating an example of a method for using the Max_len parameter according to the first embodiment. The size of a parameter that can be specified by “Max_len” is 16 bits. In the first embodiment, 4 bits from 15th to 12th bits are used for specifying a PacketIn guarantee operation code, 6 bits from 11th to 6th bits are for specifying a Reactive operation guard timer, and 6 bits from 5th to 0th bits are used for specifying a PacketIn refresh time.

The PacketIn guarantee operation code is a code indicating that a PacketIn is a guaranteed PacketIn. In the case of a guaranteed PacketIn, 15th bit is set to 1, and 14th bit is set to 0. In the case where the PacketIn guarantee operation code is 0x9(0b1001), transmission of a PacketIn for the earliest frame within a predetermined time is indicated. In the case where the PacketIn guarantee operation code is 0xA(0b1010), transmission of a PacketIn for the latest frame is indicated. Of the PacketIn guarantee operation codes, 0xB(0b1011) or 0x8(0b1000) is reserved for future expanded use. The PacketIn guarantee operation code is an example of a “value indicating that a PacketIn message is the second setting request message”.

In the case where the 15th bit, which is the most significant bit of Max_len, is 1, the frame length indicated by the 16 bits of Max_len is at least 32000 bytes. The maximum length of an IP packet is 1500 bytes. Even in the case of a jumbo frame, the frame length is less than 10000 bytes. Accordingly, conventionally, the 15th bit, which is the most significant bit of Max_len, is not set to 1. If a flow entry including Max_len where the 15th bit, which is the most significant bit, is set to 1 is set for an existing switch, the switch transmits a PacketIn including the entire frame (the maximum length).

Furthermore, by setting the 14th bit of Max_len to 0, overlap with a reservation number 0xFFFF indicating OFPCML_NO_BUFFER specified by OpenFlow may be avoided.

In the case where the 15th bit of Max_len is 1, and the 14th bit is 0, Max_len takes a value of 0x8000 to 0xBFFF. The value in the case where the 15th bit of Max_len is 1 and the 14th bit is 0 is a value smaller than a reservation number 0xFFE5 of OFPCML_MAX specified by OpenFlow, and there is no overlap.

Accordingly, even if a flow entry for a guaranteed PacketIn is set for an existing switch, the existing switch performs conventional processing, and thus the processing by the existing switch is not affected.

The value that is set in the Reactive operation guard timer indicates the maximum time length the frame main body corresponding to the guaranteed PacketIn transmitted to the controller 2 is held in the frame buffer 143 after completion of transmission of the guaranteed PacketIn. Unit of the Reactive operation guard timer is second, for example.

The Reactive operation guard timer is started with transmission of a guaranteed PacketIn as a trigger. The Reactive operation guard timer is cancelled when a PacketOut corresponding to the transmitted PacketIn is received. When the Reactive operation guard timer is expired, a frame of the corresponding flow in the frame buffer 143 is discarded by the PacketIn control unit 15. That is, the value that is set in the Reactive operation guard timer indicates the maximum time length when the PacketIn is guaranteed for the corresponding flow.

In the case where the set value of the Reactive operation guard timer is 0, it is indicated that a frame of the corresponding flow is not stored in the frame buffer 143.

Furthermore, in the case where the set value of the Reactive operation guard timer is 0, the refresh time is also set to 0 so that the latest guaranteed PacketIn in the transmission queue 16 is stored. In the case where the set value of the Reactive operation guard timer is 0, a frame is not stored in the frame buffer 143, and thus, the frame main body is included in the guaranteed PacketIn. If the frame main body is included in the guaranteed PacketIn, the guaranteed PacketIn has to be reliably stored in the transmission queue 16. This is because not more than one guaranteed PacketIn can be transmitted for one flow.

The set value 0 of the Reactive operation guard timer is advantageously set for a flow of a protocol for which reception of a PacketOut from the controller 2 is unnecessary but a PacketIn is desired to be reliably transmitted to an ARP or LLDP controller 2, for example. A PacketIn and a PacketOut are associated by a buffer ID indicating the frame buffer 143 where the frame main body is stored, for example. In the following, the Reactive operation guard timer will sometimes be referred to simply as an operation guard timer. The set value of the Reactive operation guard timer is an example of a “second time length”.

The PacketIn refresh time is a time length to be the threshold for update determination for a guaranteed PacketIn in the transmission queue 16. Unit of the PacketIn refresh time is 0.1 second, for example.

In the case where the refresh time is 0, a guaranteed PacketIn in the transmission queue 16 is overwritten with the latest PacketIn of the corresponding flow when the latest guaranteed PacketIn of the corresponding flow is input. Accordingly, in the case where the PacketIn guarantee code is 0xA, the refresh time is set to 0. Additionally, in the case where the set value of the operation guard timer is 0, the refresh time is set to 0. The refresh time is an example of a “first time length”.

Referring back to FIG. 6, the flow entry for Priority “20” is Max_len=0x9081. The PacketIn guarantee operation code is 0x9(0b1001), and thus, it is indicated that the guaranteed PacketIn for the earliest frame within a predetermined time is to be transmitted. Moreover, the value of the operation guard timer is 2 seconds (0b000010). The value of the refresh time is 0.1 second (0b000001).

Action such as that of the flow entry for Priority “20” in FIG. 6 is more advantageously set for TCP or UDP user data, for example. In many cases, for example, a flow for forwarding TCP or UDP user data includes a large number of continuous frames. Accordingly, by making the flow for forwarding TCP or UDP user data the target of guaranteed PacketIn, the number of PacketIns to be transmitted to the controller 2 may be greatly reduced.

On the other hand, guaranteed PacketIns of the same flow other than the guaranteed PacketIn to be transmitted to the controller 2 are discarded. When a PacketIn is discarded, the corresponding frame main body is also discarded, resulting in packet loss. However, with the TCP or UDP user data, in many cases, a retransmission function is provided to the upper protocol, and even in the instance of packet loss, the influence is reduced as much as possible by the function of the upper protocol.

The flow entry for Priority “30” in FIG. 6 is Max_len=0xA000. The PacketIn guarantee operation code is 0xA(0b1011), and thus, it is indicated that the guaranteed PacketIn for the latest frame is to be transmitted. Moreover, the value of the operation guard timer is 0 second, and it is indicated that the frame main body is not to be stored in the frame buffer 143.

Action such as that of the flow entry for Priority “30” in FIG. 6 is more advantageously set for LLDP or ARP flow, for example. This is because LLDP and ARP may be used in such a way that a PacketIn is desired to be reliably transmitted to the controller 2 but a PacketOut for the PacketIn does not have to be transmitted. This is also because the operation guard timer is 0, and a frame corresponding to the PacketIn is not held in the frame buffer 143, and thus, resources are not wastefully used.

The flow entry for Priority “10” in FIG. 6 is Max_len=0d1518. The PacketIn guarantee operation code is 0x0(0b0000), and thus, a normal reactive operation is performed for a flow matching the flow entry for Priority “10” in FIG. 6, and a non-guaranteed PacketIn is transmitted. Action such as that of the flow entry for Priority “10” in FIG. 6 is more advantageously set for a flow for which PacketIns may be discarded at the time of congestion but all the PacketIns are desired to be transmitted to the controller 2 on a best-effort basis.

Accordingly, in the first embodiment, the Max_len parameter is one of parameters about a PacketIn which are output together with the PacketIn to the PacketIn control unit 15 from the frame processing control unit 142.

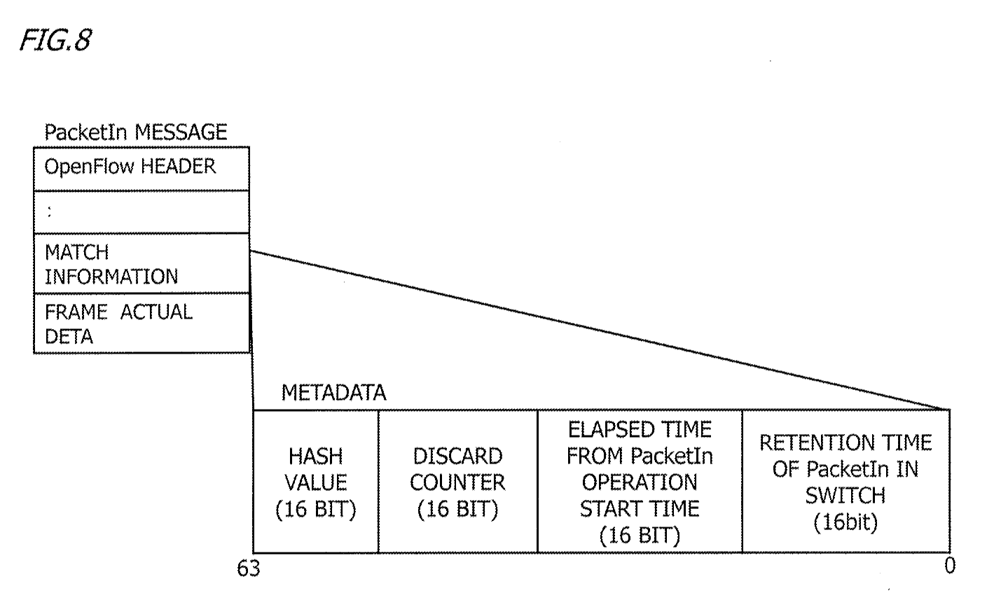

FIG. 8 is a diagram illustrating an example of congestion information that is added to a guaranteed PacketIn. In the first embodiment, the switch 1 adds the congestion information to a guaranteed PacketIn so as to notify the controller 2 of a congestion state of a flow in the switch 1.

In the first embodiment, the congestion information is transmitted by using Metadata in match information among fields of a PacketIn. The match information field of a PacketIn is a field where the value of the item, Match, of a flow entry matching a flow is stored. The size of Metadata in the match information is 64 bits.

Metadata in a guaranteed PacketIn includes a hash value, a discard counter, an elapsed time from PacketIn operation start time, and a retention time of the PacketIn in a switch, for example. Each is assigned with 16 bits.

In the field of the hash value, a predetermined value indicating that the PacketIn is guaranteed is stored. The controller 2 may determine based on the value in the field of the hash value that the PacketIn is guaranteed. The value that is stored in the field of the hash value is a value that is calculated by a predetermined hash function based on the content of the frame and the value of Cookie of the flow entry (not illustrated in FIG. 6), for example. The value of Cookie of the flow entry is a value that is specified by the controller 2. However, the value to be stored in the field of the hash value is not limited to the above, and may be a fixed value.

In the field of the discard counter, the number of discarded PacketIns of the flow of the corresponding guaranteed PacketIn is stored. The number of guaranteed PacketIns to be transmitted to the controller 2 is normally one, and it is possible to notify the controller 2, by the value of the discard counter, that a plurality of PacketIns of the corresponding flow are discarded. In the case where the value of the discard counter is 0xFFFF, overflow is indicated. The value to be stored in the discard counter is acquired from an entry in the PacketIn control table 19 described later.

The elapsed time from PacketIn operation start is the elapsed time from start of processing of a PacketIn of the corresponding flow to transmission of the PacketIn of the corresponding flow. In the first embodiment, first storage of a guaranteed PacketIn for the corresponding flow in the transmission queue 16 is taken as the start of processing of the PacketIn. Accordingly, the elapsed time from the PacketIn operation start indicates the retention time of the PacketIn of the corresponding flow in the transmission queue 16. If the elapsed time from the PacketIn operation start is long, the controller 2 may determine that there is congestion at the switch 1.

The retention time of a PacketIn in the switch indicates the retention time of the corresponding PacketIn in the switch 1. A guaranteed PacketIn in the transmission queue 16 is overwritten after a lapse of the refresh time. Accordingly, the elapsed time from the PacketIn operation start is information about the entire corresponding flow, but the retention time of a PacketIn in the switch is information about the corresponding PacketIn. In the case where there is processing congestion at the switch 1, the retention time in the transmission queue 16 becomes long, and overwriting of a guaranteed PacketIn in the transmission queue 16 is caused. Therefore, the retention time of a PacketIn in the switch is different from the elapsed time from the PacketIn operation start.

The congestion information added to a PacketIn is information at the time of transmission, that is, at the time of reading from the transmission queue 16, and it is added to a guaranteed PacketIn by the transmission rate control unit 17. Additionally, information to be added to a PacketIn is not limited to that illustrated in FIG. 8. The congestion information, illustrated in FIG. 8, to be added to a PacketIn is an example of “information about a congestion state”.

The controller 2 is enabled to analyze the congestion state at the switch 1 and the like by being notified of the number of discarded PacketIns, the elapsed time from the PacketIn operation start, the retention time of a PacketIn in the switch, and the like. The controller 2 may grasp a fault in the flow table set in the switch 1 based on the analysis information. A fault, in the flow table set in the switch 1, which is acquired based on the analysis information may be a frequent occurrence of PacketIns, for example. The controller 2 may transmit, to the switch 1, a FlowMod including a flow entry for which the fault has been corrected, by grasping the fault in the flow table.

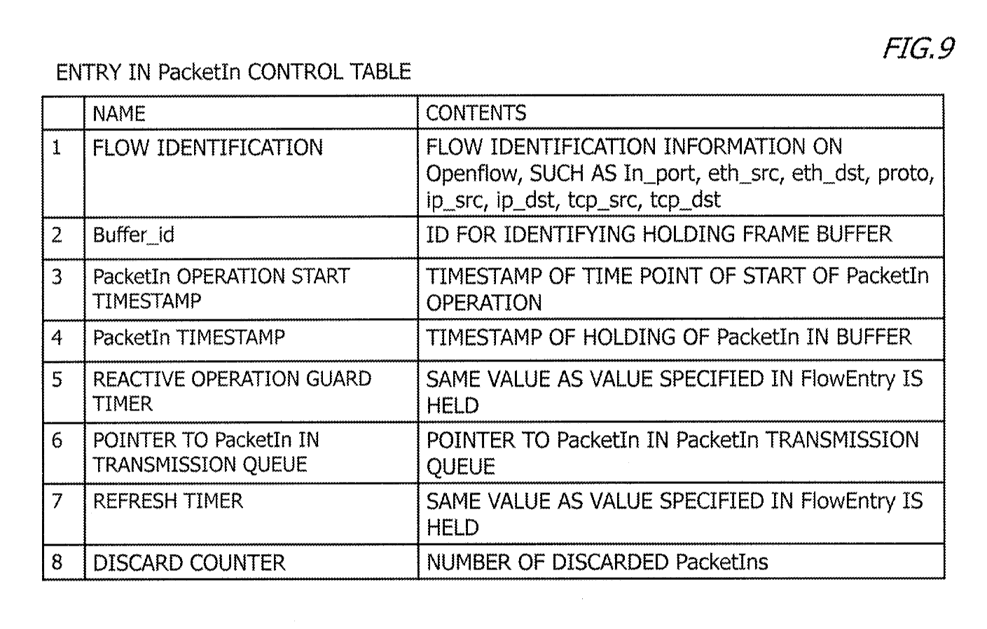

FIG. 9 is a diagram illustrating an example of items included in an entry in the PacketIn control table 19. The PacketIn control table 19 is a table holding information about a guaranteed PacketIn for a frame processing of which is being suspended. An entry in the PacketIn control table 19 is generated one for each flow of a guaranteed PacketIn. An entry in the PacketIn control table 19 is generated, updated and deleted by the PacketIn control unit 15.

An entry in the PacketIn control table 19 includes flow identification information, a buffer ID, a PacketIn operation start timestamp, a PacketIn timestamp, a Reactive operation guard timer, a pointer to a PacketIn in the transmission queue, and a discard counter, for example.

The flow identification information is a combination of a destination IP address, a source IP address, a destination MAC address, a source MAC address, a destination port number, a source port number, a protocol ID, an input port, and the like. As the flow identification information in an entry in the PacketIn control table 19, flow identification information to be notified to the PacketIn control unit 15 as one parameter regarding a PacketIn is stored. The flow identification information to be notified to the PacketIn control unit 15 is acquired by the frame analysis unit 13.

The buffer ID is the buffer ID of the frame buffer 143 where a frame of the corresponding flow is stored. What is included in the header of a PacketIn input to the PacketIn control unit 15 is acquired as the item of buffer ID.

The PacketIn operation start timestamp is the time point when the operation of a PacketIn of the corresponding flow is started. In the first embodiment, the PacketIn operation start timestamp is the time point acquired when a guaranteed PacketIn of the corresponding flow is first stored in the transmission queue 16.

The PacketIn timestamp is a time point when a PacketIn of the corresponding flow is stored in the transmission queue 16. The PacketIn timestamp is updated when a guaranteed PacketIn of the corresponding flow in the transmission queue 16 is overwritten.

Values specified by Max_len of the flow entry are stored in the items of the Reactive operation guard timer and the refresh time. When the operation guard timer expires, the PacketIn in the transmission queue 16 and the corresponding entry in the PacketIn control table 19 are deleted. When the elapsed time from the time point of the PacketIn timestamp exceeds the value of the refresh time, the PacketIn of the corresponding flow in the transmission queue 16 is overwritten with a new PacketIn.

Information indicating the storage position of the PacketIn of the corresponding flow in the transmission queue 16 is stored in the item of the pointer to a PacketIn message in standby. Information indicating the storage position of a PacketIn in the transmission queue 16 is a memory address, for example.

The number of discarded PacketIn messages of the corresponding flow is stored in the discard counter. The discard counter is updated by addition of one every time a PacketIn of the corresponding flow is discarded.

In the case where the operation guard timer is set to 0 in Max_len, a frame is not stored in the frame buffer 143. Also, in the case where the buffer ID is included in the PacketOut but a frame is not stored in the frame buffer 143, the PacketOut including buffer ID=NO_BUFFER is transmitted. Moreover, information for identifying a flow, such as the flow identification information, is not included in the PacketOut. Accordingly, an entry in the PacketIn control table 19 is not deleted by reception of the PacketOut. Accordingly, in the first embodiment, in the case where the operation guard timer is set to 0, an entry is not created in the PacketIn control table 19 for the corresponding flow.

The PacketIn control table 19 is searched through with the flow identification information or the buffer ID as the key. To increase the speed of the search process, a hash value may be included in the PacketIn control table 19 as an item in the flow entry. The hash value is calculated from the flow identification information and the buffer ID. Additionally, items in the entry in the PacketIn control table 19 are not limited to those illustrated in FIG. 9.

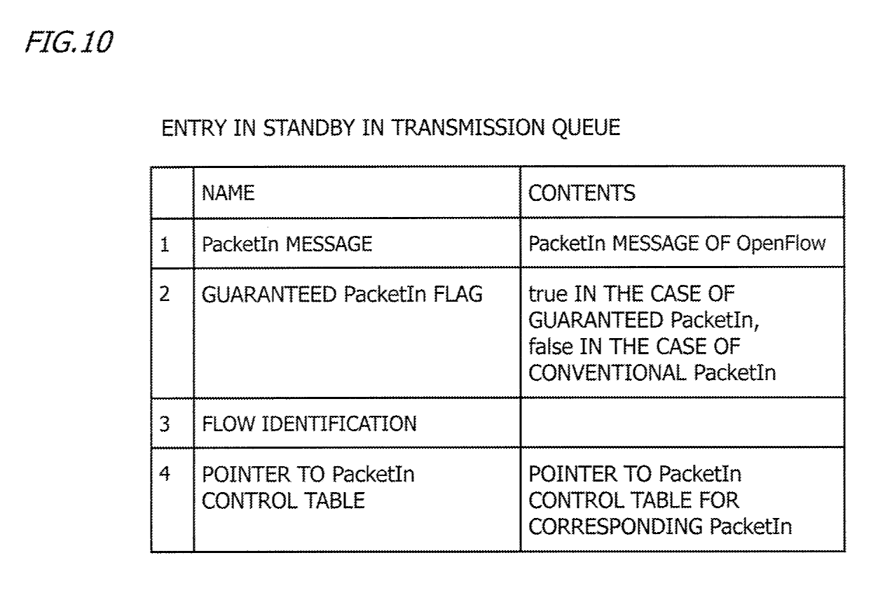

FIG. 10 is a diagram illustrating an example of items in an entry in standby in the transmission queue 16. An entry in standby in the transmission queue 16 includes items of PacketIn message, guaranteed PacketIn flag, flow identification information, and pointer to the PacketIn control table 19.

A PacketIn message main body is stored in the item of PacketIn message. A value indicating whether the corresponding PacketIn is guaranteed or non-guaranteed is stored in the item of guaranteed PacketIn flag. For example, in the case where the guaranteed PacketIn flag is True, it is indicated that the corresponding PacketIn is guaranteed. In the case where the guaranteed PacketIn flag is False, it is indicated that the corresponding PacketIn is non-guaranteed.

That which is input to the PacketIn control unit 15 together with the corresponding PacketIn is stored, as one parameter regarding the corresponding PacketIn, in the flow identification information.

Information indicating the storage position of an entry, in the PacketIn control table 19, corresponding to the flow of the corresponding PacketIn is stored in the item of pointer to the PacketIn control table. Information indicating the storage position of an entry in the PacketIn control table 19 is a memory address, for example.

An entry in standby is generated by the PacketIn control unit 15 in the case where a PacketIn is stored in the transmission queue 16. Also, the entry in standby is deleted by the transmission rate control unit 17 in the case where the corresponding PacketIn is read out or deleted from the transmission queue 16. Additionally, the items in the entry in standby in the transmission queue 16 are not limited to those illustrated in FIG. 10.

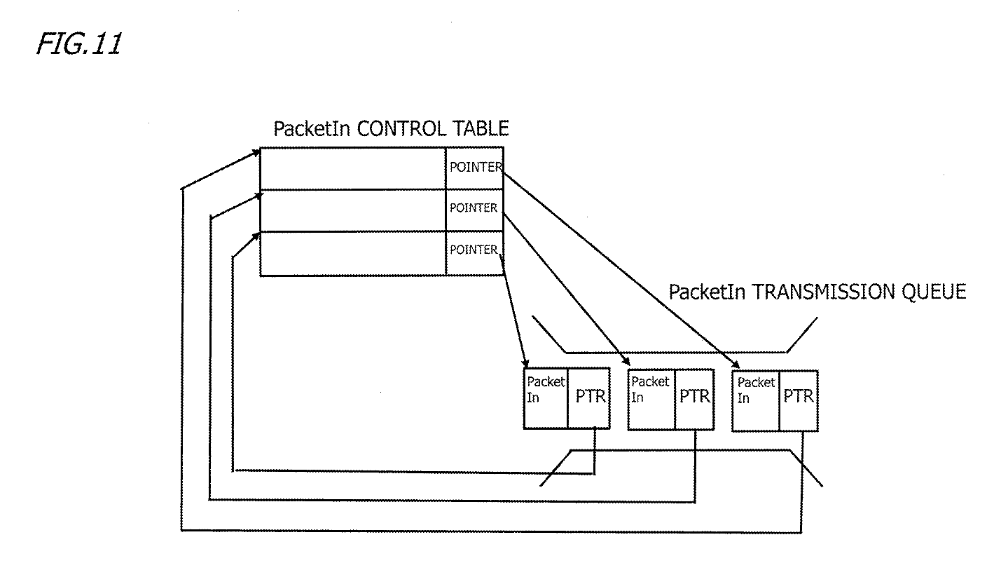

FIG. 11 is a diagram illustrating an example of mutual reference between an entry in the PacketIn control table 19 and an entry in standby in the transmission queue 16. By referring to the pointer of an entry in the PacketIn control table 19, the storage position of the corresponding PacketIn in the transmission queue 16 may be acquired. An entry, in the PacketIn control table 19, corresponding to the flow of the corresponding PacketIn may be acquired by the pointer of an entry in standby in the transmission queue 16. Mutual reference between an entry in the PacketIn control table 19 and an entry in standby in the transmission queue 16 is enabled in the above manner.

<Flow of Processing>

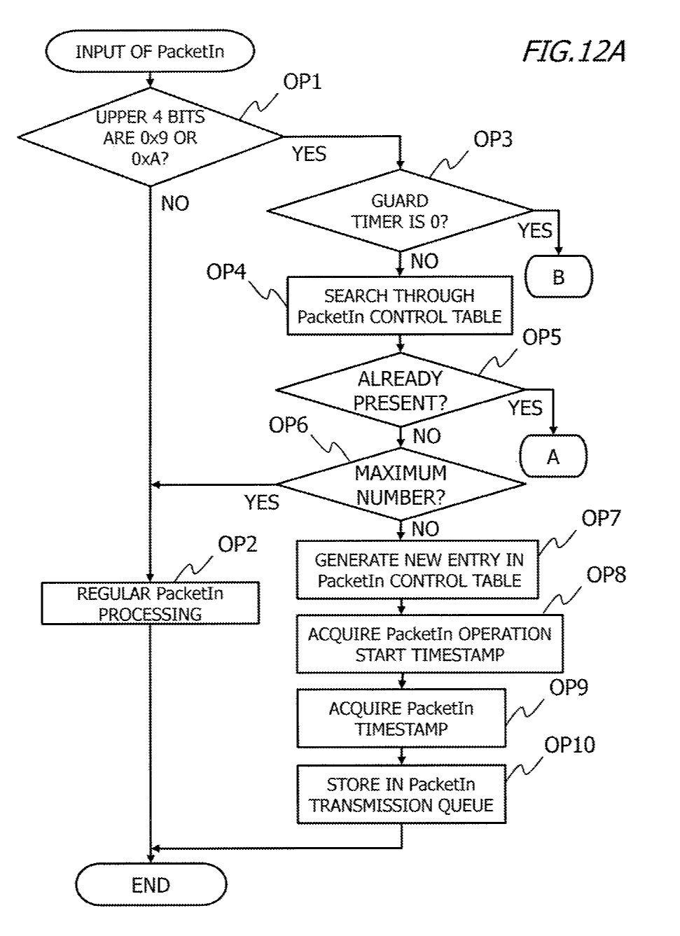

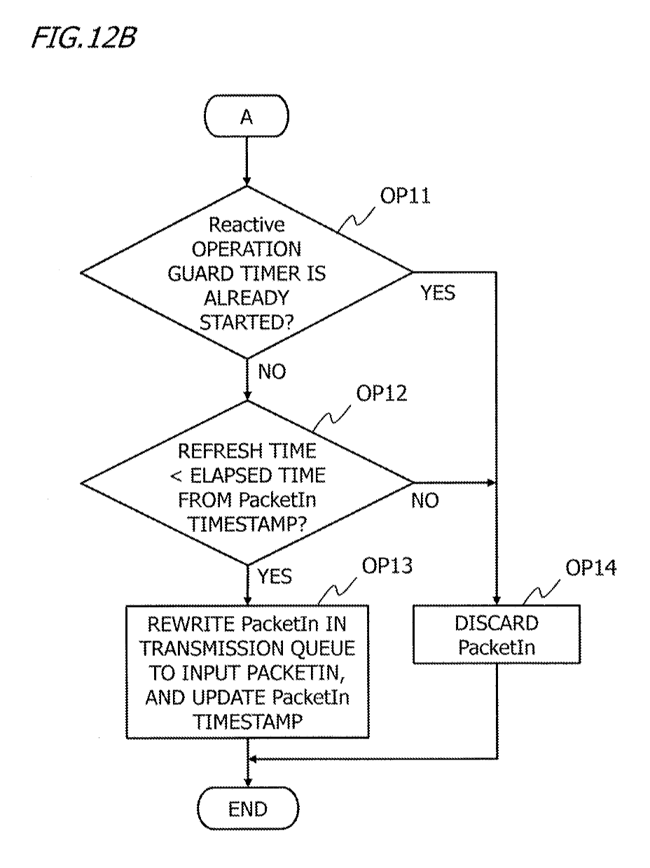

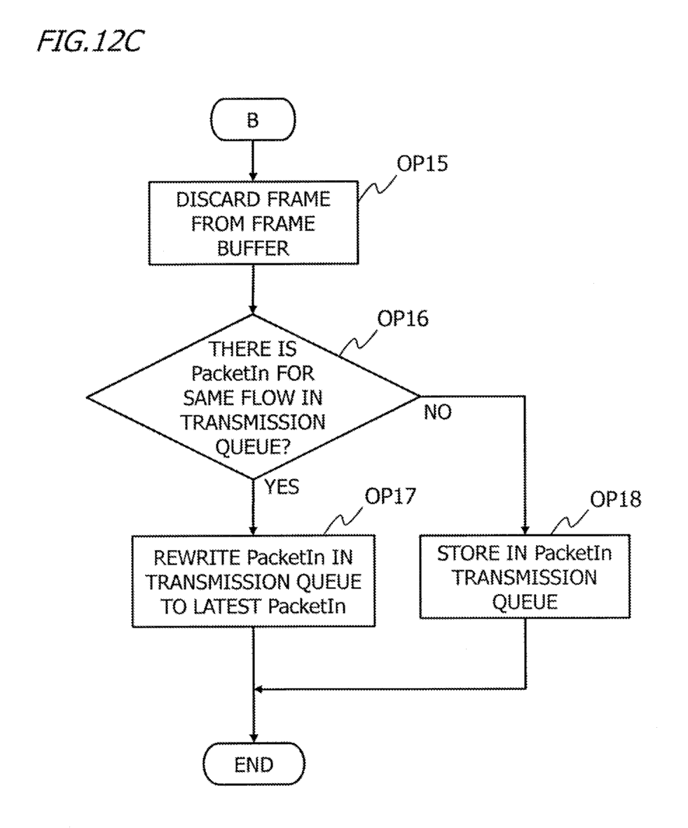

FIGS. 12A, 12B and 12C are example flowcharts of a process by the PacketIn control unit 15 performed at the time of PacketIn input. The process illustrated in FIG. 12A is started when a PacketIn is input from the frame processing unit 14. In FIGS. 12A to 12C, the process is described to be mainly performed by the PacketIn control unit 15, but the process is actually mainly performed by the CPU 101 executing the guaranteed PacketIn execution program.

In OP1, the PacketIn control unit 15 determines whether the upper 4 bits of Max_len input together with a PacketIn are 0x9 or 0xA. That is, in OP1, whether an input PacketIn is guaranteed or non-guaranteed is determined. In the case where the upper 4 bits of Max_len are 0x9 or 0xA, that is, in the case where an input PacketIn is guaranteed (OP1: YES), the process proceeds to OP3. In the case where the upper 4 bits of Max_len are neither 0x9 nor 0xA, that is, in the case where an input PacketIn is non-guaranteed (OP1: NO), the process proceeds to OP2.

In OP2, because the input PacketIn is non-guaranteed, regular PacketIn processing is performed. Specifically, the PacketIn control unit 15 stores the input non-guaranteed PacketIn in the transmission queue 16. At this time, because the PacketIn is not a guaranteed PacketIn, creation, update or the like of an entry in the PacketIn control table 19 is not performed. The process illustrated in FIG. 12A is then ended.

The process from OP3 is a process for a case where the input PacketIn is guaranteed. In OP3, the PacketIn control unit 15 determines whether the set value of the operation guard timer for the input guaranteed PacketIn is 0 or not. The set value of the operation guard timer is acquired from Max_len that is input together with the PacketIn. In the case where the set value of the operation guard timer for the input guaranteed PacketIn is 0 (OP3: YES), the process proceeds to OP15 in FIG. 12C. In the case where the set value of the operation guard timer for the input guaranteed PacketIn is not 0 (OP3: NO), the process proceeds to OP4.

In OP4, the PacketIn control unit 15 searches through the PacketIn control table 19 with the flow identification information of the input guaranteed PacketIn as the key. The flow identification information of a guaranteed PacketIn is input from the frame processing unit 14 to the PacketIn control unit 15 as one parameter regarding the PacketIn.

In OP5, the PacketIn control unit 15 determines whether an entry corresponding to the input guaranteed PacketIn already exists in the PacketIn control table 19 or not. In the case where an entry corresponding to the input guaranteed PacketIn already exists in the PacketIn control table 19 (OP5: YES), the process proceeds to OP11 in FIG. 12B. In the case where an entry corresponding to the input guaranteed PacketIn does not exist in the PacketIn control table 19 (OP5: NO), the process proceeds to OP6.

In OP6, the PacketIn control unit 15 determines whether the maximum number of entries of the PacketIn control table 19 is reached or not. The maximum number of entries in the PacketIn control table 19 is set in advance by the administrator of the network system 100. In the case where the maximum number of entries of PacketIn control table 19 is reached (OP6: YES), the process proceeds to OP2, and regular PacketIn processing is performed. In the case where the maximum number of entries of the PacketIn control table 19 is not reached (OP6: NO), the process proceeds to OP7.

In OP7, the PacketIn control unit 15 creates a new entry in the PacketIn control table 19. In OP7, values are stored in the items of flow identification information, buffer ID, Reactive operation guard timer, and refresh time for an entry in the PacketIn control table 19.

In OP8, the PacketIn control unit 15 acquires the current time point as the PacketIn operation start timestamp, and stores the same in the corresponding entry in the PacketIn control table 19.

In OP9, the PacketIn control unit 15 acquires the current time point as the PacketIn timestamp, and stores the same in the corresponding entry in the PacketIn control table 19. In the case where the refresh time is set to 0, the process in OP9 does not have to be performed.

In OP10, the PacketIn control unit 15 stores the input guaranteed PacketIn in the transmission queue 16. The PacketIn control unit 15 stores storage position information about the PacketIn in the transmission queue 16, in the item of the pointer to a PacketIn message in standby of the corresponding entry in the PacketIn control table 19. Then, the process illustrated in FIG. 12A is ended.

Processes from OP11 to OP14 in FIG. 12B are processes for a case where an entry for the flow of the input guaranteed PacketIn already exists in the PacketIn control table 19.

In OP11, the PacketIn control unit 15 refers to the entry in the PacketIn control table 19 corresponding to the flow of the input guaranteed PacketIn, and determines whether the operation guard timer is started or not. That the operation guard timer is started indicates that the guaranteed PacketIn of the corresponding flow is already transmitted to the controller 2, and that reception of a PacketOut from the controller 2 is being awaited.

In the case where the operation guard timer for the flow of the input guaranteed PacketIn is started (OP11: YES), the process proceeds to OP14, and in OP14, the PacketIn control unit 15 discards the input guaranteed PacketIn. In the case where the operation guard timer for the flow of the input guaranteed PacketIn is not started (OP11: NO), the process proceeds to OP12.

In OP12, the PacketIn control unit 15 determines whether the elapsed time from the PacketIn timestamp is longer than the refresh time or not. This determination is performed by referring to the entry in the PacketIn control table 19 corresponding to the flow of the input guaranteed PacketIn. In the case where the elapsed time from the PacketIn timestamp is not longer than the refresh time (OP12: NO), the process proceeds to OP14, and the PacketIn control unit 15 discards the input guaranteed PacketIn. In the case where the elapsed time from the PacketIn timestamp is longer than the refresh time (OP12: YES), the process proceeds to OP13. In the case where the refresh time is 0, the process proceeds to OP13.

In OP13, the PacketIn control unit 15 overwrites a PacketIn, in the transmission queue 16, of the same flow as the input guaranteed PacketIn with the input guaranteed PacketIn. The storage position of an existing guaranteed PacketIn of the same flow in the transmission queue 16 is indicated by the pointer to a PacketIn in standby in the entry in the PacketIn control table 19 corresponding to the flow of the input guaranteed PacketIn. At this time, the frame main body corresponding to the existing guaranteed PacketIn, in the transmission queue 16, which has been discarded by being overwritten is discarded from the frame buffer 143. Furthermore, the PacketIn control unit 15 updates the buffer ID in the entry in the PacketIn control table 19 corresponding to the flow of the input guaranteed PacketIn to the buffer ID included in the input guaranteed PacketIn. Additionally, the buffer ID of the frame buffer 143 where the frame corresponding to the PacketIn is stored is included in the PacketIn by the specification of OpenFlow.

Furthermore, the PacketIn control unit 15 updates the PacketIn timestamp in the entry in the PacketIn control table 19 corresponding to the flow of the input guaranteed PacketIn to the current time point. Moreover, the PacketIn control unit 15 updates the value of the discard counter in the entry in the PacketIn control table 19 corresponding to the flow of the input guaranteed PacketIn to a value increased by one. Then, the process illustrated in FIG. 12B is ended.

In OP14, the PacketIn control unit 15 discards the input guaranteed PacketIn. At this time, the frame main body corresponding to the input guaranteed PacketIn is discarded from the frame buffer 143. Furthermore, the PacketIn control unit 15 updates the value of the discard counter in the entry in the PacketIn control table 19 corresponding to the flow of the discarded PacketIn to a value increased by one. Then, the process illustrated in FIG. 12B is ended.

The processes from OP15 to OP18 in FIG. 12C are processes for a case where the set value of the operation guard timer of the input guaranteed PacketIn is 0. In OP15, the guaranteed PacketIn is deleted from the frame buffer 143. This is because, in the first embodiment, in a case where a PacketIn is generated by the frame processing control unit 142, a frame is stored in the frame buffer 143 regardless of the set value of the operation guard timer. The PacketIn control unit 15 overwrites the field in the input guaranteed PacketIn storing the buffer ID with NO_BUFFER.

In OP16, the PacketIn control unit 15 determines whether a PacketIn for the same flow as the input guaranteed PacketIn is already stored in the transmission queue 16 or not. This determination is performed by determining whether an entry in standby including the flow identification information matching the flow identification information of the input guaranteed PacketIn exists or not.

In the case where a PacketIn for the same flow as the input guaranteed PacketIn is already stored in the transmission queue 16 (OP16: YES), the process proceeds to OP17. In the case where a PacketIn for the same flow as the input guaranteed PacketIn is not stored in the transmission queue 16 (OP16: NO), the process proceeds to OP18.

In OP17, because a PacketIn for the same flow is already present in the transmission queue 16, the PacketIn control unit 15 overwrites a guaranteed PacketIn in the transmission queue 16, for the same flow, of an entry where the buffer id is NO_BUFFER, with the input guaranteed PacketIn. The buffer ID of the frame buffer 143 where the frame corresponding to the already existing guaranteed PacketIn for the same flow in the transmission queue 16 is stored is included in the PacketIn to be discarded. Additionally, in the case where the set value of the operation guard timer is 0, an entry is not created in the PacketIn control table 19 for the corresponding flow, and update of entry in the PacketIn control table 19 is not performed in OP17. Then, the process illustrated in FIG. 12C is ended.

In OP18, because a PacketIn for the same flow does not exist in the transmission queue 16, the PacketIn control unit 15 stores the input guaranteed PacketIn in the transmission queue 16. Then, the process illustrated in FIG. 12C is ended.

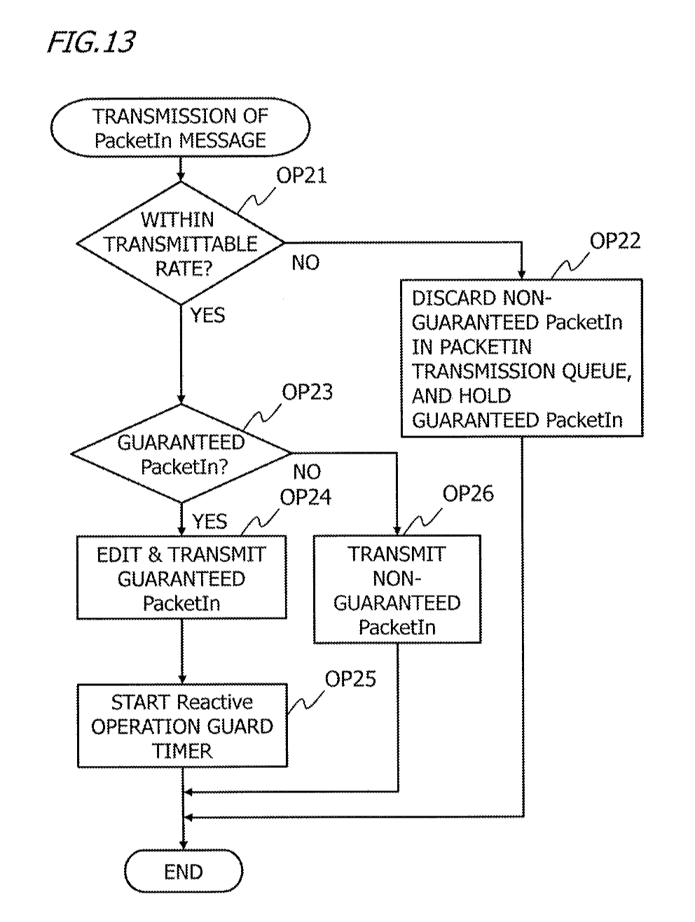

FIG. 13 is an example flowchart of a process of PacketIn transmission by the transmission rate control unit 17. The process illustrated in FIG. 13 is repeatedly performed at a predetermined rate of the transmission rate control unit 17 reading out PacketIns from the transmission queue 16. The transmission control rate for PacketIns is normally set by the controller 2. In FIG. 13, the process is described to be mainly performed by the transmission rate control unit 17, but the process is actually mainly performed by the CPU 101 executing the guaranteed PacketIn execution program.

In OP21, the transmission rate control unit 17 determines whether the current transmission rate is equal to or less than the transmittable rate. The transmittable rate is set by the controller, and is the upper limit of the transmission rate. For example, if a token is stored in the token bucket, the transmission rate is determined to be equal to or less than the transmittable rate. In the case where the transmission rate is equal to or less than the transmittable rate (OP21: YES), the process proceeds to OP23. In the case where the transmission rate is more than the transmittable rate (OP21: NO), the process proceeds to OP22.

In OP22, because the transmission rate is more than the transmittable rate, the transmission rate control unit 17 discards the non-guaranteed PacketIn in the transmission queue 16. The transmission rate control unit 17 may discard a predetermined number of non-guaranteed PacketIns, or may discard the non-guaranteed PacketIns until the transmission rate falls below the transmittable rate. In OP22, guaranteed PacketIns in the transmission queue 16 are not made the targets of discard. Additionally, a frame main body corresponding to a non-guaranteed PacketIn discarded from the transmission queue 16 is discarded from the frame buffer 143. Then, the process illustrated in FIG. 13 is ended.

The processes from OP23 to OP26 are processes for a case where the transmission rate is equal to or less than the transmittable rate. In OP23, the transmission rate control unit 17 reads out the PacketIn at the top of the transmission queue 16, and determines whether the PacketIn which has been read out is guaranteed or not. Whether the PacketIn which has been read out is guaranteed or not is determined based on the guaranteed PacketIn flag in the entry in standby for the corresponding PacketIn.

In the case where the PacketIn which has been read out is guaranteed (OP23: YES), the process proceeds to OP24. In the case where the PacketIn which has been read out is non-guaranteed (OP23: NO), the process proceeds to OP26.

In OP24, the transmission rate control unit 17 edits the guaranteed PacketIn read out from the transmission queue 16, and outputs the same to the OpenFlow protocol control unit 18. When the guaranteed PacketIn is edited by the transmission rate control unit 17, the congestion information illustrated in FIG. 8 is added to the Metadata of the PacketIn, for example.

In OP25, the transmission rate control unit 17 starts the operation guard timer for the flow of the guaranteed PacketIn which has been transmitted. Hereinafter, if a PacketIn of the corresponding flow is input to the PacketIn control unit 15, the PacketIn is discarded without being stored in the transmission queue 16. In the case where the set value of the operation guard timer for the guaranteed PacketIn read out from the transmission queue 16 is 0, there is no entry in the PacketIn control table 19, and editing in OP24 and the process in OP25 are not performed. Then, the process illustrated in FIG. 13 is ended.

OP26 is a process for case where the PacketIn read out from the transmission queue 16 is non-guaranteed. In OP26, the transmission rate control unit 17 outputs the read-out non-guaranteed PacketIn to the OpenFlow protocol control unit 18. Then, the process illustrated in FIG. 13 is ended.

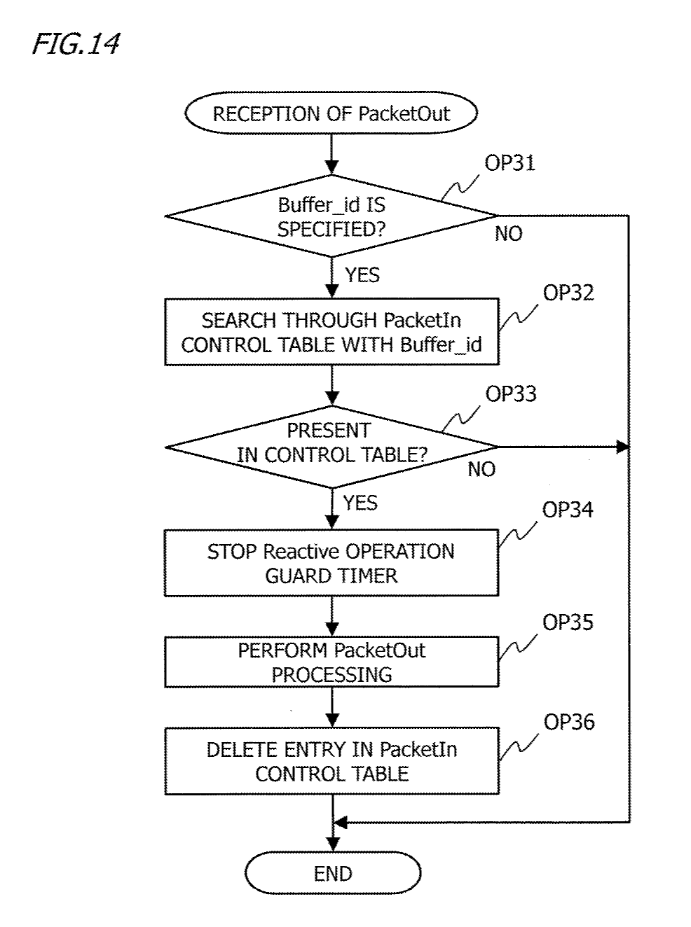

FIG. 14 is an example flowchart of a process by the PacketIn control unit 15 performed at the time of PacketOut input. The process illustrated in FIG. 14 is started when a PacketOut is input from the OpenFlow protocol control unit 18. In FIG. 14, the process is described to be mainly performed by the PacketIn control unit 15, but the process is actually mainly performed by the CPU 101 executing the guaranteed PacketIn execution program.

In OP31, the PacketIn control unit 15 determines whether a buffer ID is specified in the PacketOut or not. In the case where a buffer ID is not specified in the PacketOut (OP31: NO), the process illustrated in FIG. 14 is ended. In the case where a buffer ID is specified in the PacketOut (OP31: YES), the process proceeds to OP32.

In OP32, the PacketIn control unit 15 searches through the PacketIn control table 19 with the buffer ID specified by the PacketOut as the key.

In OP33, the PacketIn control unit 15 determines whether or not there is an entry, in the PacketIn control table 19, matching the buffer ID specified by the PacketOut. In the case where there is an entry, in the PacketIn control table 19, matching the buffer ID specified by the PacketOut (OP33: YES), the process proceeds to OP34.

In the case where there is no entry, in the PacketIn control table 19, matching the buffer ID specified by the PacketOut (OP33: NO), it is indicated that the PacketIn corresponding to the PacketOut is non-guaranteed, and the process illustrated in FIG. 14 is ended.

In OP34, the PacketIn control unit 15 cancels the operation guard timer for the corresponding entry in the PacketIn control table 19 detected in OP33.

In OP35, the PacketIn control unit 15 reads out a frame from the frame buffer 143 of the buffer ID specified by the PacketOut, and forwards the same to the frame processing control unit 142. The frame processing control unit 142 executes Action specified by the PacketOut, and processes the suspended frame according to the flow table.

In OP36, the PacketIn control unit 15 deletes the corresponding entry in the PacketIn control table 19. Then, the process illustrated in FIG. 14 is ended.

In the case where a buffer ID is not specified in the PacketOut (OP31: NO), Action specified by the PacketOut is executed by the frame processing control unit 142 in the same manner as the regular OpenFlow processing. For example, a frame included in the PacketOut is output from the switch 1.

For example, in the case where an entry matching the buffer ID specified by the PacketOut does not exist in the PacketIn control table 19 (OP33: NO), it is indicated that the PacketIn corresponding to the PacketOut is non-guaranteed. In this case, a frame is read out by the frame processing control unit 142 from the frame buffer 143 of the buffer ID specified by the PacketOut and Action specified by the PacketOut is executed, as the regular PacketOut processing according to OpenFlow.

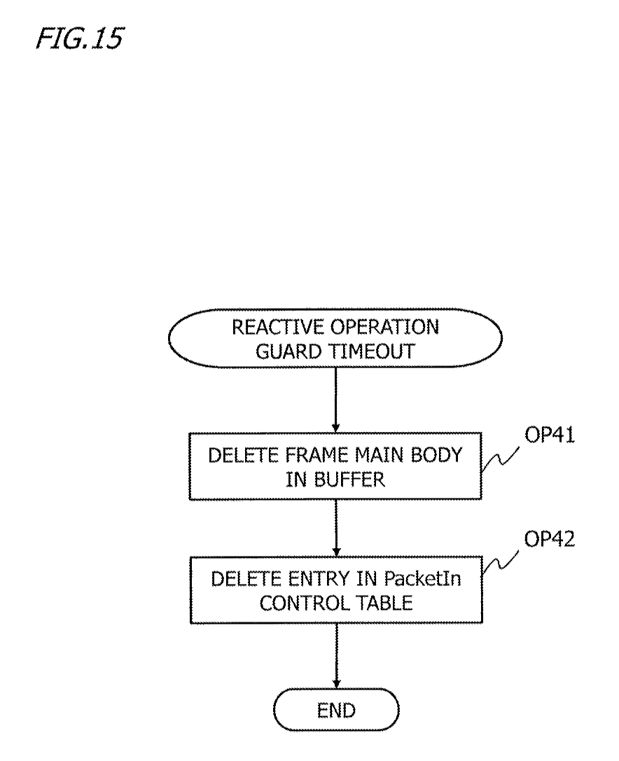

FIG. 15 is an example flowchart of a process performed by the PacketIn control unit 15 when the operation guard timer runs out. The process illustrated in FIG. 15 is started when the operation guard timer runs out for any of the entries included in the PacketIn control table 19.

In OP41, the PacketIn control unit 15 discards a frame stored in the frame buffer 143 corresponding to the value of the item of the buffer ID in the entry in the PacketIn control table 19 for which the operation guard timer ran out.

In OP42, the PacketIn control unit 15 deletes the corresponding entry in the PacketIn control table 19. Then, the process illustrated in FIG. 15 is ended.

The flowcharts illustrated in FIGS. 12A to 15 are merely examples, and the processes in each flowchart are not limited to the illustrated processes, and the order of execution of the processes may be changed or a process may be added as appropriate, for example.

<Effects of First Embodiment>

In the first embodiment, one guaranteed PacketIn is transmitted to the controller 2 for one flow. Also, even if the guaranteed PacketIn is stored in the transmission queue 16, it is excluded from the target of discard for adjustment of the transmission rate. Therefore, according to the first embodiment, the number of PacketIns to be transmitted to the controller 2 may be suppressed, and also, a guaranteed PacketIn is guaranteed to be reliably transmitted from the switch 1. The processing congestion at the controller 2 and the switch 1 may thereby be suppressed.

Furthermore, PacketIns of the same flow other than the guaranteed PacketIn to be transmitted to the controller 2 are discarded, and are not transmitted to the controller 2. Accordingly, the number of PacketIns to be input to the controller 2 may be suppressed to a small number, and the processing congestion at the controller 2 may be suppressed.

Moreover, in the case where the transmission rate of PacketIns is more than the transmittable rate, non-guaranteed PacketIns in the transmission queue 16 are discarded for adjustment of the transmission rate. Guaranteed PacketIns in the transmission queue 16 are not targets of discard. Accordingly, when a guaranteed PacketIn is stored in the transmission queue 16, it is guaranteed to be reliably transmitted to the controller 2.

When the refresh time is set to 0, a guaranteed PacketIn in the transmission queue 16 is overwritten with a newly arriving guaranteed PacketIn. Accordingly, a PacketIn for the latest frame may be transmitted to the controller 2.

Moreover, by setting the refresh time to a predetermined value, a guaranteed PacketIn in the transmission queue 16 is overwritten with a guaranteed PacketIn newly arriving after a lapse of the refresh time. Accordingly, a PacketIn for the earliest frame in the refresh time may be transmitted to the controller 2. That is, in the first embodiment, it is possible to select whether to transmit a PacketIn for the latest frame or the earliest frame.

When a guaranteed PacketIn is transmitted to the controller 2, the operation guard timer is started, and subsequently arriving PacketIns for the same flow are discarded. The number of PacketIns to be transmitted to the controller 2 may thereby be suppressed.

Also, when the operation guard timer is expired without reception of a PacketOut, a frame of the corresponding flow in the frame buffer 143 is discarded, and the corresponding entry in the PacketIn control table 19 is also deleted. Accordingly, for example, even if a PacketOut is not returned for a guaranteed PacketIn transmitted to the controller 2, a corresponding frame main body may be deleted from the frame buffer 143, and the resources may be efficiently used.

Moreover, in the case where the operation guard timer is set to 0, a frame of the corresponding flow is not stored in the frame buffer 143, and the latest PacketIn is stored in the transmission queue 16. Also, in the case where the operation guard timer is set to 0, an entry is not created in the PacketIn control table 19. Accordingly, for example, in the case where a guaranteed PacketIn for a frame of a protocol according to which a PacketOut is not returned, such as LLDP, is transmitted, the resources may be efficiently used without being wasted.

Moreover, in the first embodiment, a guaranteed PacketIn or a non-guaranteed PacketIn may be set by the parameter of Max_len in the flow entry. Also, the operation guard timer and the refresh timer may be set by the parameters of Max_len in the flow entry. Accordingly, the processing of the first embodiment may be achieved while suppressing influence on the existing OpenFlow as much as possible.

Furthermore, in the case of a guaranteed PacketIn, the most significant 2 bits of Max_len are set to 0b10. Even if a flow entry including Max_len whose most significant 2 bits are 0b10 is set in a switch not supporting the guaranteed PacketIn, the switch performs conventional PacketIn processing, and the operation of the switch is not interrupted. Accordingly, with the network system 100, the switch 1 supporting the guaranteed PacketIn and a switch not supporting the guaranteed PacketIn may exist in a mixed manner.

Furthermore, in the first embodiment, the congestion information is included in the Metadata of a guaranteed PacketIn, and thus, the controller 2 is able to be notified of the congestion information. The controller 2 is able to grasp the congestion state of the switch 1 based on the congestion information added to a guaranteed PacketIn, and is able to perform processing according to the congestion state.

Moreover, when a guaranteed PacketIn is set for a frame of a flow of TCP or UDP user data, the processing congestion at the controller 2 and the switch 1 is able to be suppressed while suppressing the influence on the flow of the user data, and the efficiency is able to be increased. This is because, with the TCP or UDP user data, the retransmission function is often provided to the upper protocol, and thus, even in the instance of packet loss, the influence is able to be reduced as much as possible due to the function of the upper protocol.

According to the frame forwarding device and the method for requesting setting of processing for a flow according to the disclosure, processing congestion at a controller and a switch is able to be suppressed.

<Others>

In the first embodiment, the frame processing control unit 142 generates a PacketIn for each frame matching the flow entry instructing for PacketIn, and outputs the PacketIn to the PacketIn control unit 15. However, this is not restrictive, and the PacketIn control unit 15 may generate the PacketIn, and the PacketIn may be generated for at least one frame matching the flow entry.

For example, the frame processing control unit 142 outputs a parameter regarding PacketIn to the PacketIn control unit 15 without generating a PacketIn for a frame matching a flow entry instructing for PacketIn. A parameter regarding PacketIn is the flow identification information, the value of Max_len, the buffer ID of the frame buffer 143 storing a frame, or the like, for example. In the case where the input parameter indicates non-guaranteed, the PacketIn control unit 15 generates a PacketIn, and stores the same in the transmission queue 16.

In the case where the input parameter indicates guaranteed, the PacketIn control unit 15 generates a guaranteed PacketIn and stores the same in the transmission queue 16 in the following case, for example. For example, this is a case where there is no entry in the PacketIn control table 19 matching the input parameter. For example, this is a case where a guaranteed PacketIn for the same flow is already stored in the transmission queue 16, and the set value of the operation timer is 0 and the refresh time is 0, or the retention time is longer than the refresh time. In this case, the guaranteed PacketIn in the transmission queue 16 is overwritten with the generated PacketIn.

Moreover, the PacketIn control unit 15 does not generate a guaranteed PacketIn in the following case, for example. This is a case where the operation guard timer for the corresponding flow is already started, for example. Also, this is a case where a guaranteed PacketIn for the same flow already exists in the transmission queue 16, and the retention time of the guaranteed PacketIn is equal to or less than the refresh time, for example.

<Recording Medium>

A program for causing a computer, any other machine or device (hereinafter “computer or the like”) to achieve any of the functions described above may be recorded in a recording medium that can be read by the computer or the like. A function may be provided by the computer or the like reading and executing the program in the recording medium.

The recording medium that can be read by the computer or the like refers to a non-transitory recording medium that accumulates information such as data and programs electrically, magnetically, optically, mechanically or by chemical action and that can be read by the computer or the like. Among such recording mediums, those that can be removed from the computer or the like include a flexible disc, a magneto-optic disc, a CD-ROM, a CD-R/W, a DVD, a Blu-ray disc, a DAT, an 8 mm tape, a memory card such as a flash memory, and the like. Also, a hard disc, a ROM (Read-Only Memory), and the like may be cited as the recording mediums fixed in the computer or the like. Moreover, an SSD (Solid State Drive) may be used as a recording medium that can be removed from the computer or the like, or as a recording medium that is fixed in the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A frame forwarding device comprising:
a receiver that receives a frame;
a storage that stores in association with each other a condition of a flow that includes a plurality of frames having common identification information and that is a target of processing, and a processing content that is set by a control device; and
a processor configured to perform, on the received frame, a processing content that is stored in association with a condition matching identification information of the received frame,
wherein, when requesting the control device to set a processing content for the received frame, the processor is configured to determine, according to a flow type of the received frame, whether to transmit a setting request message regarding the received frame to the control device or not.

2. The frame forwarding device according to claim 1, wherein the processor is configured to:
determine to transmit the setting request message regarding the received frame when a flow including the received frame is a flow of a first flow type or when the flow including the received frame is a flow of a second flow type and the setting request message is not transmitted to the control device for any of frames in the flow including the received frame; and
determine not to transmit the setting request message regarding the received frame when the flow including the received frame is a flow of the second flow type and the setting request message is already transmitted to the control device for any other of the frames in the flow including the received frame.

3. The frame forwarding device according to claim 1, wherein the processor is configured to:
generate a first setting request message that is a target of discard for adjustment of transmission rate when the flow including the received frame is a flow of the first flow type; and
generate a second setting request message that is excluded from the target of discard for adjustment of the transmission rate when the flow including the received frame is a flow of the second flow type.

4. The frame forwarding device according to claim 3, further comprising a transmission queue that stores first and the second setting request messages in standby,
wherein, when the transmission rate is more than a predetermined value, the processor configured to adjust the transmission rate by discarding a predetermined number of first setting request messages in the transmission queue.

5. The frame forwarding device according to claim 4, wherein, when the flow including the received frame is a flow of the second flow type, and a second setting request message for the flow including the received frame is already stored in the transmission queue, the processor is configured to overwrite a second setting request message in the transmission queue with the second setting request message for the received frame.

6. The frame forwarding device according to claim 4, wherein the processor is configured to discard the second setting request message for the received frame when the flow including the received frame is a flow of the second flow type and an elapsed time from storage of a second setting request message for the flow including the received frame in the transmission queue is equal to or less than a first time length, overwrite the second setting request message stored in the transmission queue with the second request message for the received frame and reset the elapsed time when the elapsed time is longer than the first time length.

7. The frame forwarding device according to claim 3, further comprising a frame buffer that holds frames corresponding to a first and a second setting request messages, wherein, when an elapsed time from transmission of a second setting request message reaches a second time length with no reception of a predetermined message corresponding to the second setting request message from the control device, the processor is configured to discard a frame corresponding to the second setting request message from the frame buffer.

8. The frame forwarding device according to claim 7, wherein, when the flow including the received frame is a flow of the second flow type, and the second time length is set to 0 for the flow including the received frame, the processer in configured not to cause the frame buffer to hold the received frame.

9. The frame forwarding device according to claim 3,
wherein a setting request message is a PacketIn message,
the storage stores a flow entry including the second flow type as a condition of a flow as the target of processing, and including, as the processing content, at least an instruction for transmission of a PacketIn message to the control device and Max_len, and
the Max_len includes a value indicating that the PacketIn message is a second setting request message.

10. The frame forwarding device according to claim 9, wherein most significant 2 bits of the Max_len are 0b10 when the PacketIn message is a second setting request message.

11. The frame forwarding device according to claim 3, wherein the processor is configured to add, to a second setting request message, information about a congestion state, at the frame forwarding device, of a flow including a frame corresponding to the second setting request message.

12. The frame forwarding device according to of claim 2,
wherein the first flow type indicates a flow of a best-effort protocol, and
the second flow type indicates a flow of a protocol with a retransmission function.

13. A method for requesting setting of processing for a flow, the method executed by a frame forwarding device and comprising:
receiving a frame,
storing, in a storage, in association with each other a condition of a flow that includes a plurality of frames having common identification information and that is a target of processing, and a processing content that is set by a control device,
performing, on the received frame, a processing content that is stored in association with a condition matching identification information of the received frame, and
determining, according to a flow type of the received frame, when requesting the control device to set a processing content for the received frame, whether to transmit a setting request message regarding the received frame to the control device or not.
